(19) United States
(12) Patent Application Publication
(10) Pub. No.: US 2026/0252654 A1
(43) Pub. Date: Aug. 27, 2026

(54) SYSTEM

(71) Applicant: SoftBank Group Corp., Tokyo (JP)

(72) Inventor: Shoya KUSUNOSE, Tokyo (JP)

(73) Assignee: SoftBank Group Corp., Tokyo (JP)

(21) Appl. No.: 19/539,210

(22) Filed: Feb. 13, 2026

(30) Foreign Application Priority Data
Feb. 21, 2025 (JP) 2025-026970

(51) Int. Cl. G06F 16/9535; G10L 15/22

(52) U.S. Cl. CPC G06F 16/9535; G10L 15/22

(57) ABSTRACT

The system according to the embodiment comprises a receiving unit, an analysis unit, and a proposal unit. The receiving unit receives an utterance input. The analysis unit analyzes the utterance input received by the receiving unit. The proposal unit makes a proposal based on a result analyzed by the analysis unit.

### CROSS-REFERENCE TO RELATED APPLICATION

The present application claims priority to and incorporates by reference the entire contents of Japanese Patent Application No. 2025-026970 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, it is difficult to accurately interpret the intention of a counterpart's utterance, which may lead to misunderstandings or discrepancies in recognition.

### SUMMARY OF THE INVENTION

The system according to the embodiment comprises a receiving unit, an analysis unit, and a proposal unit. The receiving unit receives an utterance input. The analysis unit analyzes the utterance input received by the receiving unit. The proposal unit makes a proposal based on a result analyzed by the analysis unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### [First Embodiment]

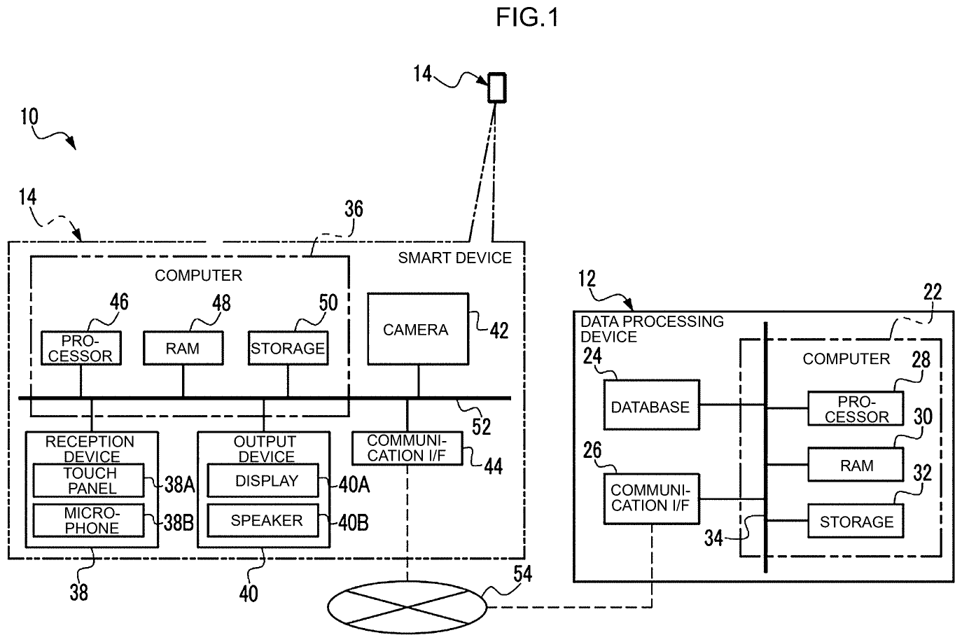

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

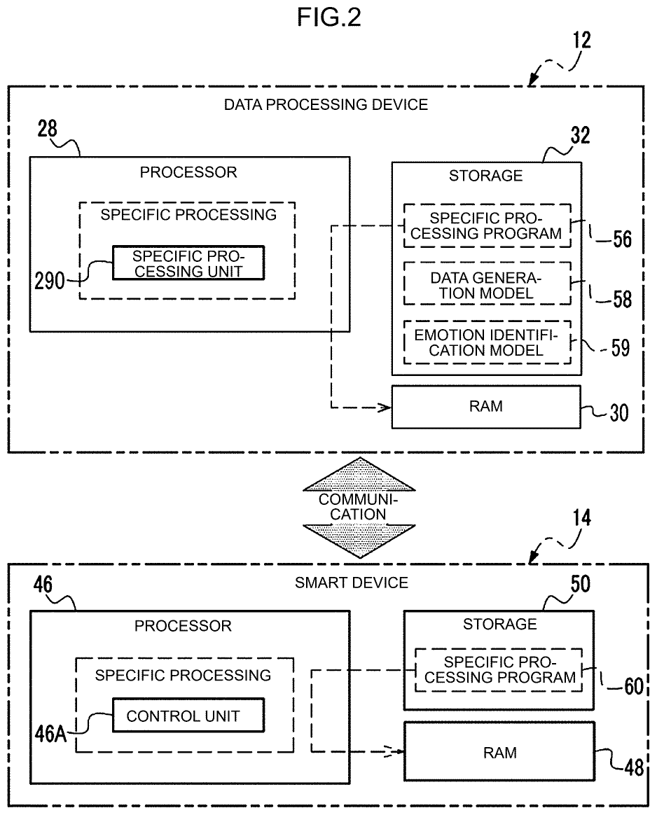

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### EXAMPLE OF THE EMBODIMENT

The communication support system according to the embodiment of the present invention is a system that uses generative AI to read the intention behind the counterpart's words and avoid misunderstandings or discrepancies in recognition. This communication support system receives the utterance of the counterpart, and the generative AI understands and analyzes the context and cultural background of the utterance, and proposes an appropriate response to achieve smooth communication. For example, when there is an utterance based on the cultural background of a specific region, it may not actually be a proposal, but rather indicate a different intention. An AI that correctly reads such intentions of the counterpart assists in smooth communication. First, the user inputs the counterpart's utterance. For example, the utterance “proposal of a specific dish” is input. This utterance is input to the generative AI. Next, the generative AI analyzes the input utterance. The generative AI understands the context and cultural background of the utterance and reads the intention of the counterpart. For example, for the utterance “proposal of a specific dish,” the generative AI analyzes that it is not actually a proposal, but has a different intention. Based on the analysis result, the generative AI proposes an appropriate response to the user. For example, it may make a proposal such as “The counterpart seems to have a different intention.” This allows the user to correctly understand the counterpart's intention and take an appropriate response. With this mechanism, misunderstandings and discrepancies in recognition in communication can be avoided. By correctly reading the counterpart's intention, the user can achieve smooth communication. For example, in business situations, correctly understanding the counterpart's intention enables smooth negotiations and cooperation. Also, in daily life, correctly reading the counterpart's intention can help avoid misunderstandings and troubles. Thus, the communication support system can correctly read the counterpart's intention and avoid misunderstandings or discrepancies in recognition. Specifically, this communication support system receives utterance data input by the user (e.g., Japanese text strings, character strings converted from voice data, natural language sentences of 20 to 200 tokens in length) as input. The system first uses a tokenizer or morphological analyzer in the preprocessing unit to perform word segmentation and part-of-speech tagging on the input utterance, and the context information extraction unit extracts the immediately preceding and following utterance history and conversation flow as time-series tensors (e.g., utterance history vectors, up to 10 utterances, each utterance embedded as a vector). The system extracts place names, idioms, and cultural reference terms in the utterance in the cultural background estimation unit, and estimates the cultural context of the utterance by matching with external knowledge bases (e.g., regional culture databases, language feature dictionaries). The system integrates these feature quantities (context vectors, cultural feature vectors, utterance embedding vectors, etc.) and inputs them into a Transformer-type large language model (e.g., 12 layers, hidden layer size 768, with self-attention mechanism). The large language model outputs intention labels behind the utterance (e.g., “direct proposal,” “evasive refusal,” “social nicety,” etc.) and intention scores (probability values from 0 to 1) from the input sequence. For example, for the utterance “proposal of a specific dish,” the model may output the label “evasive refusal” (score 0.82). Based on the output intention label and score, the proposal generation unit generates specific response proposals such as “The counterpart seems to have a different intention” or “This utterance may be a social nicety.” The output format is structured data such as text messages, action plans, and cautionary messages. Furthermore, the system can learn the user's past response history and feedback to personalize the proposal content. As a technical effect, the present invention not only automates the human task of intention estimation, but also achieves highly accurate and fast intention estimation by combining integrated analysis of context and cultural features in high-dimensional vector space, simultaneous processing of multiple modalities, and non-conventional rule-based processing (e.g., cultural background estimation algorithms), surpassing conventional simple keyword extraction or rule-based judgment. This contributes to reducing misunderstandings and improving communication efficiency in a wide range of fields, such as business negotiation support, prevention of misunderstandings at international conferences, intercultural communication education, and customer support automation. In terms of causality, the integrated analysis of context and cultural features and the large language model enable highly accurate extraction of complex intentions behind utterances, allowing users to select responses with fewer misunderstandings than before. Variations of the embodiment include support for multimodal input (voice, image, text), multilingual support, real-time inference, and large-scale operation via cloud distributed processing.

The communication support system according to the embodiment comprises a receiving unit, an analysis unit, and a proposal unit. The receiving unit receives utterances input by the user. The utterance may include, for example, voice utterances or text utterances, but is not limited to such examples. The receiving unit may, for example, receive voice input via a microphone and convert it into text data using speech recognition technology. The receiving unit may also directly receive text input. The analysis unit uses generative AI to analyze the utterance received by the receiving unit. The analysis may be performed using, for example, natural language processing technology or emotion analysis technology, but is not limited to such examples. For example, the generative AI understands the context and cultural background of the utterance and reads the intention of the counterpart. The generative AI may use a text generative AI (e.g., LLM) to analyze the context of the utterance. The generative AI may also use a multimodal generative AI to understand the context and cultural background of the utterance. The proposal unit proposes an appropriate response to the user based on the result analyzed by the analysis unit. The proposal may be made in the form of, for example, an action plan or feedback, but is not limited to such examples. For example, the proposal unit correctly reads the intention of the counterpart and makes a proposal to the user such as “The counterpart seems to have a different intention.” This allows the user to correctly understand the counterpart's intention and take an appropriate response. Some or all of the above-described processing in the proposal unit may be performed using AI, or may be performed without using AI. For example, the proposal unit may use an AI model that receives the result analyzed by the analysis unit as input and outputs an appropriate response to make a proposal. Thus, the communication support system according to the embodiment enables smooth reception, analysis, and proposal of utterances, thereby avoiding misunderstandings or discrepancies in recognition. Specifically, this communication support system receives utterance data input by the user in the receiving unit (e.g., Japanese text strings, character strings converted from voice data, natural language sentences of 20 to 200 tokens in length) as input. In the case of voice input, the receiving unit preprocesses the audio waveform data obtained from a microphone (sampling rate 16 kHz, 16 bit PCM, etc.) using an acoustic feature extractor (e.g., MFCC, spectrogram conversion), and converts it into a character string using a speech recognition engine (e.g., CTC-based acoustic model plus language model). In the case of text input, the receiving unit directly receives natural language text strings. The receiving unit performs word segmentation and part-of-speech tagging on the input utterance using a tokenizer or morphological analyzer, and the context information extraction unit extracts the immediately preceding and following utterance history and conversation flow as time-series tensors (e.g., utterance history vectors, up to 10 utterances, each utterance embedded as a vector). The analysis unit extracts place names, idioms, and cultural reference terms in the utterance in the cultural background estimation unit, and estimates the cultural context of the utterance by matching with external knowledge bases (e.g., regional culture databases, language feature dictionaries). The analysis unit integrates these feature quantities (context vectors, cultural feature vectors, utterance embedding vectors, etc.) and inputs them into a Transformer-type large language model (e.g., 12 layers, hidden layer size 768, with self-attention mechanism). Examples of input to the AI include (1) a Japanese text string such as “Shall we go eat a specific dish today?”, (2) an English text string such as “Let's go to sushi tonight.”, and (3) a short utterance such as “How about tomorrow?” The AI tokenizes and embeds these inputs, and inputs them to the model together with utterance history and cultural features. The output from the AI is structured data such as (1) intention labels (e.g., “direct proposal,” “evasive refusal,” “social nicety,” etc.), (2) intention scores (probability values from 0 to 1), and (3) estimated emotion values behind the utterance (e.g., positive 0.7, negative 0.2, neutral 0.1). For example, for the utterance “proposal of a specific dish,” the model may output the label “evasive refusal” (score 0.82). The proposal unit generates specific response proposals such as “The counterpart seems to have a different intention” or “This utterance may be a social nicety” in the proposal generation unit based on the output intention label and score. The output format is structured data such as text messages, action plans, and cautionary messages. Furthermore, the proposal unit can learn the user's past response history and feedback to personalize the proposal content. In subsequent processing, when the user selects a proposal, the selection history is recorded in a database and referenced in subsequent proposal generation. As a technical effect, the present invention not only automates the human task of intention estimation, but also achieves highly accurate and fast intention estimation by combining integrated analysis of context and cultural features in high-dimensional vector space, simultaneous processing of multiple modalities, and non-conventional rule-based processing (e.g., cultural background estimation algorithms), surpassing conventional simple keyword extraction or rule-based judgment. In terms of causality, the integrated analysis of context and cultural features and the large language model enable highly accurate extraction of complex intentions behind utterances, allowing users to select responses with fewer misunderstandings than before. Specific application fields include business negotiation support, prevention of misunderstandings at international conferences, intercultural communication education, and customer support automation. Variations of the embodiment include support for multimodal input (voice, image, text), multilingual support, real-time inference, and large-scale operation via cloud distributed processing.

The analysis unit can analyze the context and cultural background of an utterance. The analysis unit may, for example, analyze the context of the utterance. The context may include, for example, preceding and following utterances or related topics, but is not limited to such examples. The analysis unit may analyze preceding and following utterances to understand the context of the utterance. The analysis unit may also analyze related topics to understand the context of the utterance. Furthermore, the analysis unit analyzes the cultural background of the utterance. The cultural background may include, for example, regional customs or language characteristics, but is not limited to such examples. The analysis unit may analyze regional customs to understand the cultural background of the utterance. The analysis unit may also analyze language characteristics to understand the cultural background of the utterance. By understanding the context and cultural background of the utterance, the intention of the counterpart can be correctly read. Some or all of the above-described processing in the analysis unit may be performed using generative AI, or may be performed without using generative AI. For example, the analysis unit may use a generative AI model that receives the context and cultural background of the utterance as input and outputs the intention of the counterpart to perform the analysis. Specifically, the analysis unit receives input utterance data (e.g., Japanese text strings, natural language sentences of 20 to 200 tokens in length, character strings from speech recognition results), and first performs word segmentation and part-of-speech tagging using a tokenizer or morphological analyzer. Next, the context information extraction unit extracts the immediately preceding and following utterance history and conversation flow as time-series tensors (e.g., utterance history vectors, up to 10 utterances, each utterance embedded as a vector). In related topic analysis, the system matches with external knowledge bases (e.g., Wikipedia knowledge graph, industry term dictionary) to estimate which topic the utterance belongs to. In cultural background analysis, the system extracts place names, idioms, and cultural reference terms in the utterance and estimates the cultural context of the utterance by matching with regional culture databases and language feature dictionaries. The analysis unit integrates these feature quantities (context vectors, cultural feature vectors, utterance embedding vectors, etc.) and inputs them into a Transformer-type large language model (e.g., 12 layers, hidden layer size 768, with self-attention mechanism). Examples of input to the AI include (1) a Japanese text string such as “Shall we go eat a specific dish today?” plus the immediately preceding utterance history vector plus cultural feature vector, (2) an English text string such as “Let's go to sushi tonight.” plus conversation history plus place name feature vector, and (3) a short utterance such as “How about tomorrow?” plus related topic vector. The AI tokenizes and embeds these inputs, and inputs them to the model together with utterance history and cultural features. The output from the AI is structured data such as (1) intention labels (e.g., “direct proposal,” “evasive refusal,” “social nicety,” etc.), (2) intention scores (probability values from 0 to 1), and (3) estimated emotion values behind the utterance (e.g., positive 0.7, negative 0.2, neutral 0.1). For example, for the utterance “proposal of a specific dish,” the model may output the label “evasive refusal” (score 0.82). In subsequent processing, the proposal unit generates specific response proposals based on the output intention label and score. As a technical effect, the present invention enables multilayered analysis of context and cultural features, which is difficult with simple keyword extraction or rule-based judgment, and enables highly accurate extraction of complex intentions behind utterances, allowing users to select responses with fewer misunderstandings than before. Specific application fields include business negotiation support, prevention of misunderstandings at international conferences, intercultural communication education, and customer support automation. Variations of the embodiment include support for multimodal input (voice, image, text), multilingual support, real-time inference, and large-scale operation via cloud distributed processing.

The proposal unit can analyze the intention of the counterpart. The proposal unit may, for example, analyze the intention of the counterpart. The intention may include, for example, the purpose of the utterance or the expression of emotion, but is not limited to such examples. The proposal unit may analyze the purpose of the utterance to understand the intention of the counterpart. The proposal unit may also analyze the expression of emotion to understand the intention of the counterpart. By correctly reading the intention of the counterpart, appropriate responses can be proposed. Some or all of the above-described processing in the proposal unit may be performed using generative AI, or may be performed without using generative AI. For example, the proposal unit may use a generative AI model that receives the intention of the counterpart as input and outputs an appropriate response to perform the analysis. Specifically, the proposal unit receives as input structured data output from the analysis unit, such as intention labels (e.g., “direct proposal,” “evasive refusal,” “social nicety,” etc.), intention scores (probability values from 0 to 1), and estimated emotion values (e.g., positive 0.7, negative 0.2, neutral 0.1). The proposal unit applies a proposal generation algorithm (e.g., rule-based plus large language model hybrid) based on these input values to generate optimal response proposals for the user. Examples of input to the AI include (1) intention label “evasive refusal” plus score 0.82 plus estimated emotion value, (2) intention label “social nicety” plus score 0.65 plus utterance history vector, and (3) intention label “direct proposal” plus score 0.95 plus cultural feature vector. The AI outputs specific response proposals such as “The counterpart seems to have a different intention,” “This utterance may be a social nicety,” or “The counterpart is seriously proposing” as text messages or action plans based on these inputs. The output format is structured data such as (1) text messages, (2) action plans, and (3) cautionary messages. In subsequent processing, when the user selects a proposal, the selection history is recorded in a database and referenced in subsequent proposal generation. As a technical effect, the present invention not only automates the human task of intention estimation, but also achieves highly accurate and fast intention estimation and response proposal generation by combining integrated analysis of high-dimensional features by AI and rule-based processing, surpassing conventional simple keyword extraction or rule-based judgment. In terms of causality, by integrally analyzing diverse features such as intention labels, scores, and emotion values, users can select responses with fewer misunderstandings than before. Specific application fields include business negotiation support, prevention of misunderstandings at international conferences, intercultural communication education, and customer support automation. Variations of the embodiment include methods for learning the user's past response history and feedback to personalize proposal content, multilingual support, real-time inference, and large-scale operation via cloud distributed processing.

The proposal unit can propose a response to the user. The proposal unit may, for example, propose a response to the user. The response may include, for example, action plans or feedback, but is not limited to such examples. The proposal unit may propose an action plan and indicate specific actions to the user. The proposal unit may also propose feedback and indicate points for improvement to the user. By proposing appropriate responses, smooth communication can be achieved. Some or all of the above-described processing in the proposal unit may be performed using generative AI, or may be performed without using generative AI. For example, the proposal unit may use a generative AI model that receives the response as input and outputs an appropriate proposal to perform the proposal. Specifically, the proposal unit receives as input structured data output from the analysis unit, such as intention labels (e.g., “direct proposal,” “evasive refusal,” “social nicety,” etc.), intention scores (probability values from 0 to 1), and estimated emotion values (e.g., positive 0.7, negative 0.2, neutral 0.1). The proposal unit applies a proposal generation algorithm (e.g., rule-based plus large language model hybrid) based on these input values to generate optimal response proposals for the user. Examples of input to the AI include (1) intention label “evasive refusal” plus score 0.82 plus estimated emotion value, (2) intention label “social nicety” plus score 0.65 plus utterance history vector, and (3) intention label “direct proposal” plus score 0.95 plus cultural feature vector. The AI outputs specific response proposals such as “The counterpart seems to have a different intention,” “This utterance may be a social nicety,” or “The counterpart is seriously proposing” as text messages or action plans based on these inputs. The output format is structured data such as (1) text messages, (2) action plans, and (3) cautionary messages. In subsequent processing, when the user selects a proposal, the selection history is recorded in a database and referenced in subsequent proposal generation. As a technical effect, the present invention achieves highly accurate and fast intention estimation and response proposal generation by combining integrated analysis of high-dimensional features by AI and rule-based processing, surpassing conventional simple keyword extraction or rule-based judgment. In terms of causality, by integrally analyzing diverse features such as intention labels, scores, and emotion values, users can select responses with fewer misunderstandings than before. Specific application fields include business negotiation support, prevention of misunderstandings at international conferences, intercultural communication education, and customer support automation. Variations of the embodiment include methods for learning the user's past response history and feedback to personalize proposal content, multilingual support, real-time inference, and large-scale operation via cloud distributed processing.

The receiving unit can estimate the emotion of a user and adjust the timing for receiving the utterance based on the estimated emotion of the user. The receiving unit may, for example, estimate the emotion of the user. The emotion may include, for example, tension, excitement, fatigue, but is not limited to such examples. The receiving unit may estimate the emotion of the user using facial expression analysis technology. The receiving unit may also estimate the emotion of the user using voice analysis technology. Furthermore, the receiving unit adjusts the timing for receiving the utterance based on the estimated emotion of the user. For example, if the user is tense, the utterance is received at a timing when the user can relax. If the user is excited, the utterance may be received after waiting until the user calms down. If the user is fatigued, the utterance may be received after a break. By adjusting the timing for receiving the utterance according to the user's emotion, the utterance can be received at a more appropriate timing. Emotion estimation is realized using, for example, an emotion engine or generative AI with emotion estimation functionality. The generative AI may be, for example, a text generative AI (e.g., LLM) or a multimodal generative AI, but is not limited to such examples. Some or all of the above-described processing in the receiving unit may be performed using AI, or may be performed without using AI. For example, the receiving unit may input the user's emotion data to the generative AI and have the generative AI perform emotion estimation. Specifically, the receiving unit simultaneously acquires the user's facial image data (e.g., RGB image, resolution 128×128 pixels), audio waveform data (e.g., 16 kHz sampling, 1-5 seconds audio clip), and utterance text data (e.g., natural language sentences of 20-200 tokens), and preprocesses these using a multimodal feature extractor (e.g., CNN-based facial feature extraction network, acoustic feature extractor, BERT-based text embedding model). The receiving unit integrates the extracted features (e.g., 256-dimensional facial feature vector, 128-dimensional acoustic feature vector, 768-dimensional text embedding vector) and inputs them into a multimodal emotion estimation model (e.g., Transformer-type, with self-attention mechanism, 6 layers, hidden layer size 512). Examples of input to the AI include (1) a facial image of the user frowning plus utterance text “I'm busy today” plus low-pitched voice waveform, and (2) a facial image of the user smiling plus utterance text “I'm looking forward to it” plus high-pitched voice waveform. The AI outputs emotion labels (e.g., “tension,” “excitement,” “fatigue,” etc.) and emotion scores (probability values from 0 to 1) from these inputs. For example, for input (1), the label “tension” (score 0.78) may be output, and for input (2), the label “excitement” (score 0.85) may be output. The receiving unit applies a speech reception timing control algorithm (e.g., threshold judgment plus rule-based branching) based on the output emotion label and score, and dynamically adjusts the timing, such as waiting for a certain period when the “tension” score is high, providing a cool-down period when the “excitement” score is high, and resuming reception after a break when the “fatigue” score is high. In subsequent processing, the adjustment history of reception timing may be recorded in a database and the optimal parameters for each user may be learned sequentially. As a technical effect, the present invention not only automates human emotion observation, but also achieves highly accurate and flexible reception timing adjustment tailored to the user's psychological state by combining integrated analysis of multimodal high-dimensional features and dynamic timing control by AI, surpassing conventional simple timer control or static rule-based reception. In terms of causality, the linkage between the output of the emotion estimation AI and the reception timing control algorithm enables reception that responds to changes in the user's state, contributing to smoother communication and stress reduction. Specific application fields include customer support reception terminals, remote medical interview systems, educational support chatbots, and stress management support tools. Variations of the embodiment include methods that use biometric sensor data (heart rate, skin potential, etc.) from wearable devices as additional input, real-time video analysis for emotion estimation, and large-scale user support via cloud collaboration.

The receiving unit can analyze a user's past utterance history and select a receiving method. The receiving unit may, for example, analyze the user's past utterance history. The utterance history may include, for example, past utterance content or frequency, but is not limited to such examples. The receiving unit may preferentially receive utterance formats that have been frequently used in the past. The receiving unit may also analyze past utterance patterns and select the optimal timing for reception. Furthermore, the receiving unit may refer to past utterance content and preferentially receive related utterances. By analyzing the user's past utterance history, the optimal receiving method can be selected. Some or all of the above-described processing in the receiving unit may be performed using generative AI, or may be performed without using generative AI. For example, the receiving unit may input the user's past utterance history to the generative AI and have the generative AI select the optimal receiving method. Specifically, the receiving unit maintains a time-series database of more than 100 utterance history records per user (e.g., utterance text strings, utterance timestamps, utterance format tags (voice/text), utterance length, utterance category, etc.). The receiving unit extracts features from the utterance history (e.g., utterance frequency vector, utterance format one-hot vector, topic distribution vector, utterance timing histogram, etc.) and applies a history analysis AI model (e.g., LSTM-type time-series model, hidden layer size 256, 3 layers) using these as input. Examples of input to the AI include (1) utterance text strings for the past 30 days plus utterance timestamps plus utterance format tags, (2) topic distribution vector frequently appearing in the past plus utterance length histogram, and (3) usage frequency vector for each utterance category. The AI outputs structured data such as (1) optimal receiving format (e.g., voice priority, text priority), (2) optimal receiving timing (e.g., morning priority, night priority), and (3) priority score for related utterances (0 to 1) from these inputs. For example, if the user has frequently used voice utterances in the past, the system recommends “voice priority” reception format, and if there are many utterances on a specific topic, the system controls to preferentially receive utterances related to that topic. In subsequent processing, the receiving unit dynamically switches the display order and reception mode of the reception UI based on the AI output, and sequentially accumulates the user's selection history as learning data. As a technical effect, the present invention not only automates the recording of utterance history and human selection of receiving methods, but also achieves highly accurate and flexible selection of receiving methods optimized for each user by integrating time-series analysis of high-dimensional history features by AI and reception control, surpassing conventional static reception methods. In terms of causality, the linkage between the output of the history analysis AI and the dynamic control of the receiving unit enables reception that responds to the user's utterance tendencies and usage patterns, contributing to improved user experience and optimization of reception efficiency. Specific application fields include customer support reception systems, educational support chatbots, medical interview reception terminals, and personal assistants. Variations of the embodiment include recommendation of reception methods by clustering using group history of multiple users, sequential optimization by real-time history updates, and large-scale history analysis via cloud distributed processing.

The receiving unit can perform filtering at the time of receiving the utterance based on the current situation and field of interest of the user. The receiving unit may, for example, filter utterances considering the user's current situation. The current situation may include, for example, the user's location information or activity status, but is not limited to such examples. The receiving unit may, for example, preferentially receive utterances related to work when the user is working. The receiving unit may also preferentially receive relaxing utterances when the user is on a break. Furthermore, the receiving unit may filter utterances considering the user's field of interest. The field of interest may include, for example, past utterance content or topics of interest, but is not limited to such examples. The receiving unit may, for example, preferentially receive utterances related to topics the user is currently interested in. The receiving unit may also filter utterances based on the user's current activity (e.g., exercising, reading). By filtering utterances based on the user's current situation and field of interest, utterances with high relevance can be preferentially received. Some or all of the above-described processing in the receiving unit may be performed using generative AI, or may be performed without using generative AI. For example, the receiving unit may input the user's current situation and field of interest to the generative AI and have the generative AI perform utterance filtering. Specifically, the receiving unit acquires the user's current situation data (e.g., GPS location information, activity sensor data (acceleration, heart rate), calendar schedule information, device usage log, etc.) and field of interest data (e.g., topic distribution vector of utterances for the past 30 days, web browsing history, purchase history, etc.). The receiving unit preprocesses these data using a feature extractor (e.g., one-hot vectorization of location information, time-series vectorization of activity sensor data, vectorization of topic distribution) to generate an integrated feature vector (e.g., 512 dimensions). The receiving unit applies a filtering AI model (e.g., MLP-type 3-layer network, hidden layer 256, ReLU activation) using the integrated feature vector as input. Examples of input to the AI include (1) “Current location: office+activity: using PC+field of interest: business-related,” (2) “Current location: cafe+activity: reading+field of interest: hobby-related,” and (3) “Current location: gym+activity: exercising+field of interest: health.” The AI outputs filtering results such as reception priority score (0 to 1) and reception permission label (e.g., “priority reception,” “normal reception,” “reception pending”) from these inputs. For example, for (1), “business-related utterance: priority reception” is output; for (2), “hobby-related utterance: priority reception”; and for (3), “health-related utterance: priority reception.” In subsequent processing, the receiving unit dynamically controls the display order and reception permission of the utterance reception UI based on the AI output, and sequentially accumulates the user's selection history as learning data. As a technical effect, the present invention not only automates human situation judgment and field of interest selection, but also achieves highly accurate and flexible reception filtering tailored to the user's situation and interests by combining integrated analysis of multimodal high-dimensional features and dynamic filtering control by AI, surpassing conventional static rule-based reception. In terms of causality, the linkage between AI analysis of situation and field of interest features and the receiving unit enables reception that responds to the user's current state and interests, contributing to improved communication efficiency and user satisfaction. Specific application fields include personal assistants, customer support reception terminals, educational support systems, and health management apps. Variations of the embodiment include real-time activity recognition for reception control, group reception optimization considering the situation of multiple users, and large-scale situation analysis via cloud collaboration.

The receiving unit can estimate the emotion of a user and determine a priority of the utterance to be received based on the estimated emotion of the user. The receiving unit may, for example, estimate the emotion of the user. The emotion may include, for example, tension, relaxation, urgency, but is not limited to such examples. The receiving unit may estimate the emotion of the user using facial expression analysis technology. The receiving unit may also estimate the emotion of the user using voice analysis technology. Furthermore, the receiving unit determines the priority of the utterance to be received based on the estimated emotion of the user. For example, if the user is tense, important utterances are preferentially received. If the user is relaxed, utterances on light topics may be preferentially received. If the user is in a hurry, utterances requiring prompt response may be preferentially received. By determining the priority of the utterance to be received according to the user's emotion, important utterances can be preferentially received. Emotion estimation is realized using, for example, an emotion engine or generative AI with emotion estimation functionality. The generative AI may be, for example, a text generative AI (e.g., LLM) or a multimodal generative AI, but is not limited to such examples. Some or all of the above-described processing in the receiving unit may be performed using AI, or may be performed without using AI. For example, the receiving unit may input the user's emotion data to the generative AI and have the generative AI determine the priority of the utterance to be received. Specifically, the receiving unit simultaneously acquires the user's facial image data (e.g., RGB image, resolution 128×128 pixels), audio waveform data (e.g., 16 kHz sampling, 1-5 seconds audio clip), and utterance text data (e.g., natural language sentences of 20-200 tokens), and preprocesses these using a multimodal feature extractor (e.g., CNN-based facial feature extraction network, acoustic feature extractor, BERT-based text embedding model). The receiving unit integrates the extracted features (e.g., 256-dimensional facial feature vector, 128-dimensional acoustic feature vector, 768-dimensional text embedding vector) and inputs them into a multimodal emotion estimation model (e.g., Transformer-type, with self-attention mechanism, 6 layers, hidden layer size 512). Examples of input to the AI include (1) a facial image of the user frowning plus utterance text “I'm busy today” plus low-pitched voice waveform, and (2) a facial image of the user smiling plus utterance text “I'm looking forward to it” plus high-pitched voice waveform. The receiving unit outputs emotion labels (e.g., “tension,” “relaxation,” “urgency,” etc.) and emotion scores (probability values from 0 to 1) from these inputs. For example, for input (1), the label “tension” (score 0.78) may be output, and for input (2), the label “relaxation” (score 0.85) may be output. The receiving unit applies a speech priority determination algorithm (e.g., threshold judgment plus rule-based branching) based on the output emotion label and score, and dynamically controls the priority, such as prioritizing important utterances when the “tension” score is high, prioritizing light topics when the “relaxation” score is high, and prioritizing utterances requiring prompt response when the “urgency” score is high. The AI outputs structured data such as (1) priority score for each utterance (0 to 1), and (2) priority reception label (e.g., “highest priority,” “normal,” “deferred”). For example, important business communication utterances are labeled “highest priority,” and casual conversation utterances are labeled “normal.” In subsequent processing, the receiving unit dynamically controls the display order and notification timing of the utterance reception UI based on the priority determination result, and sequentially accumulates the user's selection history as learning data. As a technical effect, the present invention not only automates human emotion observation and utterance prioritization, but also achieves highly accurate and flexible utterance priority determination tailored to the user's psychological state and situation by combining integrated analysis of multimodal high-dimensional features and dynamic priority control by AI, surpassing conventional static rule-based reception. In terms of causality, the linkage between the output of the emotion estimation AI and the priority determination algorithm enables priority reception of important utterances that responds to changes in the user's state, contributing to improved communication efficiency and reduction of misunderstandings and oversights. Specific application fields include customer support reception terminals, remote medical interview systems, educational support chatbots, and stress management support tools. Variations of the embodiment include methods that use biometric sensor data (heart rate, skin potential, etc.) from wearable devices as additional input, real-time video analysis for emotion estimation, large-scale user support via cloud collaboration, and simultaneous priority optimization for multiple users.

The receiving unit can preferentially receive utterances with high relevance based on geographic location information of the user at the time of receiving the utterance. The receiving unit may, for example, filter utterances considering the user's geographic location information. Geographic location information may include, for example, GPS data or location information services, but is not limited to such examples. The receiving unit may, for example, preferentially receive utterances related to the region when the user is in a specific region. The receiving unit may also preferentially receive utterances related to the travel destination when the user is traveling. Furthermore, the receiving unit may preferentially receive utterances related to the home when the user is at home. By considering the user's geographic location information, utterances with high relevance can be preferentially received. Some or all of the above-described processing in the receiving unit may be performed using generative AI, or may be performed without using generative AI. For example, the receiving unit may input the user's geographic location information to the generative AI and have the generative AI perform utterance filtering. Specifically, the receiving unit receives GPS location information (e.g., latitude/longitude pair, accuracy within 5 m), Wi-Fi/Bluetooth beacon information, and device location history data (e.g., movement trajectory vector for the past 24 hours) obtained from the user terminal as input data. The receiving unit preprocesses these location information using a feature extractor (e.g., one-hot vectorization of location information, time-series vectorization of movement patterns) to generate a current location feature vector (e.g., 128 dimensions). The receiving unit integrates the current location feature vector and region tag/category information of utterance candidates (e.g., region relevance score for each utterance) and inputs them into a filtering AI model (e.g., MLP-type 3-layer network, hidden layer 256, ReLU activation). Examples of input to the AI include (1) “Current location: Chiyoda-ku, Tokyo+utterance candidate: Tokyo event information,” (2) “Current location: Kyoto City+utterance candidate: tourist information,” and (3) “Current location: home (latitude/longitude)+utterance candidate: household communication.” The AI outputs filtering results such as reception priority score (0 to 1) and reception permission label (e.g., “priority reception,” “normal reception,” “reception pending”) from these inputs. For example, for (1), “Tokyo event information: priority reception” is output; for (2), “tourist information: priority reception”; and for (3), “household communication: priority reception.” In subsequent processing, the receiving unit dynamically controls the display order and reception permission of the utterance reception UI based on the AI output, and sequentially accumulates the user's selection history and location change history as learning data. As a technical effect, the present invention not only automates human location judgment and utterance selection, but also achieves highly accurate and flexible utterance reception filtering tailored to the user's current location and movement status by combining integrated analysis of high-dimensional location information and utterance content and dynamic filtering control by AI, surpassing conventional static rule-based reception. In terms of causality, the linkage between AI analysis of location features and the receiving unit enables reception that responds to the user's current location and movement patterns, contributing to improved communication efficiency and user satisfaction. Specific application fields include tourist information chatbots, region-limited service reception terminals, business communication support during movement, and household IoT-linked reception. Variations of the embodiment include real-time movement recognition for reception control, group reception optimization considering the location information of multiple users, and large-scale location information analysis via cloud collaboration.

The receiving unit can analyze the user's social media activity at the time of receiving the utterance and receive relevant utterances. The receiving unit may, for example, analyze the user's social media activity. Social media activity may include, for example, post content or follower reactions, but is not limited to such examples. The receiving unit may, for example, preferentially receive utterances related to topics frequently mentioned by the user on social media. The receiving unit may also filter utterances by referring to the user's recent post content on social media. Furthermore, the receiving unit may preferentially receive utterances considering the user's social media friendships. By analyzing the user's social media activity, relevant utterances can be preferentially received. Some or all of the above-described processing in the receiving unit may be performed using generative AI, or may be performed without using generative AI. For example, the receiving unit may input the user's social media activity to the generative AI and have the generative AI perform utterance filtering. Specifically, the receiving unit receives post data obtained from the user's social media account (e.g., text of the most recent 100 posts, post timestamps, post category tags), follower/friend list, and reaction data to posts (e.g., number of likes, comment content, number of shares) as input data. The receiving unit extracts features such as topic distribution vector from post content (e.g., topic estimation by LDA or BERT, 128 dimensions), post frequency histogram, and friend relationship graph features (e.g., centrality score, cluster ID). The receiving unit integrates these features and topic tags/relevance scores of utterance candidates and inputs them into a filtering AI model (e.g., MLP-type 3-layer network, hidden layer 256, ReLU activation). Examples of input to the AI include (1) “Recent post topic: sports+utterance candidate: sports viewing topic,” (2) “Friend relationship: technology cluster+utterance candidate: new technology introduction,” and (3) “Post frequency: many travel category+utterance candidate: travel planning.” The AI outputs filtering results such as reception priority score (0 to 1) and reception permission label (e.g., “priority reception,” “normal reception,” “reception pending”) from these inputs. For example, for (1), “sports viewing topic: priority reception” is output; for (2), “new technology introduction: priority reception”; and for (3), “travel planning: priority reception.” In subsequent processing, the receiving unit dynamically controls the display order and reception permission of the utterance reception UI based on the AI output, and sequentially accumulates the user's selection history and social media activity history as learning data. As a technical effect, the present invention not only automates human analysis of post content and utterance selection, but also achieves highly accurate and flexible utterance reception filtering tailored to the user's interests and friendships by combining integrated analysis of high-dimensional social media activity and utterance content and dynamic filtering control by AI, surpassing conventional static rule-based reception. In terms of causality, the linkage between AI analysis of social media features and the receiving unit enables reception that responds to the user's latest interests and friendships, contributing to improved communication efficiency and user satisfaction. Specific application fields include personal assistants, customer support reception terminals, SNS-linked chatbots, and information distribution for hobby/interest groups. Variations of the embodiment include integrated analysis of multiple SNS accounts, real-time post monitoring for reception control, and large-scale social data analysis via cloud collaboration.

The analysis unit can estimate the emotion of a user and adjust an analysis method for the utterance based on the estimated emotion of the user. The analysis unit may, for example, estimate the emotion of the user. The emotion may include, for example, tension, relaxation, urgency, but is not limited to such examples. The analysis unit may estimate the emotion of the user using facial expression analysis technology. The analysis unit may also estimate the emotion of the user using voice analysis technology. Furthermore, the analysis unit adjusts the analysis method for the utterance based on the estimated emotion of the user. For example, if the user is tense, a simple analysis method is applied. If the user is relaxed, a detailed analysis method may be applied. If the user is in a hurry, a method for providing analysis results quickly may be applied. By adjusting the analysis method for the utterance according to the user's emotion, more appropriate analysis results can be provided. Emotion estimation is realized using, for example, an emotion engine or generative AI with emotion estimation functionality. The generative AI may be, for example, a text generative AI (e.g., LLM) or a multimodal generative AI, but is not limited to such examples. Some or all of the above-described processing in the analysis unit may be performed using AI, or may be performed without using AI. For example, the analysis unit may input the user's emotion data to the generative AI and have the generative AI adjust the analysis method for the utterance. Specifically, the analysis unit simultaneously acquires the user's facial image data (e.g., RGB image, resolution 128×128 pixels), audio waveform data (e.g., 16 kHz sampling, 1-5 seconds audio clip), and utterance text data (e.g., natural language sentences of 20-200 tokens), and preprocesses these using a multimodal feature extractor (e.g., CNN-based facial feature extraction network, acoustic feature extractor, BERT-based text embedding model). The analysis unit integrates the extracted features (e.g., 256-dimensional facial feature vector, 128-dimensional acoustic feature vector, 768-dimensional text embedding vector) and inputs them into a multimodal emotion estimation model (e.g., Transformer-type, with self-attention mechanism, 6 layers, hidden layer size 512). Examples of input to the AI include (1) a facial image of the user frowning plus utterance text “I'm busy today” plus low-pitched voice waveform, and (2) a facial image of the user smiling plus utterance text “I'm looking forward to it” plus high-pitched voice waveform. The analysis unit outputs emotion labels (e.g., “tension,” “relaxation,” “urgency,” etc.) and emotion scores (probability values from 0 to 1) from these inputs. For example, for input (1), the label “tension” (score 0.78) may be output, and for input (2), the label “relaxation” (score 0.85) may be output. The analysis unit applies an analysis method selection algorithm (e.g., threshold judgment plus rule-based branching) based on the output emotion label and score, and dynamically selects the analysis pipeline, such as selecting a fast and simple analysis pipeline (e.g., main keyword extraction plus simple intention estimation) when the “tension” score is high, selecting a detailed analysis pipeline (e.g., integrated context and cultural feature analysis plus multi-stage intention estimation plus emotional nuance analysis) when the “relaxation” score is high, and applying real-time inference mode (e.g., reduced batch size plus accelerated inference) when the “urgency” score is high. The AI outputs structured data such as (1) analysis method selection label (e.g., “simple,” “detailed,” “fast”), and (2) analysis parameter set (e.g., model ID used, analysis depth, timeout threshold, etc.). For example, in the “tension” state, “simple” label plus timeout 2 seconds is output; in the “relaxation” state, “detailed” label plus analysis depth 3 stages; and in the “urgency” state, “fast” label plus batch size 1. In subsequent processing, the analysis unit dynamically switches the utterance analysis pipeline according to the selected analysis method and sends the analysis result to the proposal unit. As a technical effect, the present invention not only automates human emotion observation and analysis method selection, but also achieves highly accurate and flexible selection of utterance analysis methods tailored to the user's psychological state and situation by combining integrated analysis of multimodal high-dimensional features and dynamic analysis pipeline control by AI, surpassing conventional static rule-based analysis. In terms of causality, the linkage between the output of the emotion estimation AI and the analysis method selection algorithm enables analysis that responds to changes in the user's state, contributing to improved analysis accuracy and user satisfaction. Specific application fields include customer support automatic response, remote medical interview analysis, educational support chatbots, and stress management support tools. Variations of the embodiment include methods that use biometric sensor data (heart rate, skin potential, etc.) from wearable devices as additional input, real-time video analysis for emotion estimation, large-scale user support via cloud collaboration, and simultaneous optimization of analysis methods for multiple users.

The analysis unit can set a level of detail of analysis based on an importance of the utterance at the time of analyzing the utterance. The analysis unit may, for example, evaluate the importance of the utterance. The importance may include, for example, the content or impact of the utterance, but is not limited to such examples. The analysis unit may perform detailed analysis for important utterances. The analysis unit may also perform simplified analysis for utterances on light topics. Furthermore, the analysis unit may perform rapid analysis for urgent utterances. By adjusting the level of detail of analysis based on the importance of the utterance, detailed analysis can be performed for important utterances. Some or all of the above-described processing in the analysis unit may be performed using generative AI, or may be performed without using generative AI. For example, the analysis unit may input the importance of the utterance to the generative AI and have the generative AI adjust the level of detail of analysis. Specifically, the analysis unit receives utterance data (e.g., Japanese text strings, natural language sentences of 20-200 tokens, character strings from speech recognition results), and extracts importance features from the utterance content (e.g., keyword occurrence frequency, utterance category, past impact score, urgency tag, etc.). The analysis unit applies an importance estimation AI model (e.g., MLP-type 3-layer network, hidden layer 256, ReLU activation) using these features as input, and outputs an importance score (0 to 1) and urgency label (e.g., “high,” “medium,” “low”) for each utterance. Examples of input to the AI include (1) “Business communication: notification of delivery date change” text plus past impact score 0.9, (2) “Casual conversation: weekend plans” text plus impact score 0.2, and (3) “Urgent: system failure report” text plus urgency tag “high.” The AI outputs structured data such as (1) analysis detail label (e.g., “detailed,” “simple,” “fast”), and (2) analysis parameter set (e.g., model ID used, analysis depth, timeout threshold, etc.). For example, for an utterance with importance score 0.9, “detailed” label plus analysis depth 3 stages is output; for an utterance with score 0.2, “simple” label plus analysis depth 1 stage; and for an utterance with urgency “high,” “fast” label plus timeout 1 second. In subsequent processing, the analysis unit dynamically switches the utterance analysis pipeline according to the selected level of detail and sends the analysis result to the proposal unit. As a technical effect, the present invention not only automates human judgment of utterance importance and selection of analysis detail, but also achieves highly accurate and flexible selection of analysis detail tailored to utterance content, impact, and urgency by combining integrated analysis of high-dimensional features by AI and dynamic analysis pipeline control, surpassing conventional static rule-based analysis. In terms of causality, the linkage between the output of the importance estimation AI and the analysis detail control algorithm enables optimal analysis for important or urgent utterances, contributing to improved analysis accuracy and faster response. Specific application fields include automatic analysis of business communication, emergency reporting systems, educational support chatbots, and customer support automatic response. Variations of the embodiment include personalization of importance criteria for each user, real-time re-evaluation of importance, and large-scale utterance analysis via cloud distributed processing.

The analysis unit can use different analysis algorithms according to a category of the utterance at the time of analyzing the utterance. The analysis unit may, for example, identify the category of the utterance. The category may include, for example, business-related, daily conversation, technical utterances, but is not limited to such examples. The analysis unit may apply a business analysis algorithm for business-related utterances. The analysis unit may also apply a daily conversation analysis algorithm for daily conversation utterances. Furthermore, the analysis unit may apply a technical analysis algorithm for technical utterances. By applying different analysis algorithms according to the category of the utterance, more appropriate analysis results can be provided. Some or all of the above-described processing in the analysis unit may be performed using generative AI, or may be performed without using generative AI. For example, the analysis unit may input the category of the utterance to the generative AI and have the generative AI apply the analysis algorithm. Specifically, the analysis unit receives utterance data (e.g., Japanese text strings, natural language sentences of 20-200 tokens, character strings from speech recognition results), and extracts category features from the utterance content (e.g., keyword distribution vector, topic distribution vector, past category labels, etc.). The analysis unit applies a category classification AI model (e.g., BERT-based text classification model, hidden layer size 768, 12 layers) using these features as input, and outputs a category label (e.g., “business,” “daily conversation,” “technical,” etc.) and category score (0 to 1) for each utterance. Examples of input to the AI include (1) “Meeting minutes” text, (2) “Weekend plans” text, and (3) “Introduction of new technology” text. The AI outputs structured data such as (1) analysis algorithm selection label (e.g., “business,” “daily conversation,” “technical”), and (2) analysis parameter set (e.g., model ID used, analysis depth, etc.). For example, “Meeting minutes” is assigned the “business” algorithm, “Weekend plans” the “daily conversation” algorithm, and “Introduction of new technology” the “technical” algorithm. In subsequent processing, the analysis unit dynamically switches the utterance analysis pipeline according to the selected analysis algorithm and sends the analysis result to the proposal unit. As a technical effect, the present invention not only automates human judgment of category and selection of analysis algorithm, but also achieves highly accurate and flexible selection of analysis algorithm tailored to utterance category by combining integrated analysis of high-dimensional features by AI and dynamic algorithm selection control, surpassing conventional static rule-based analysis. In terms of causality, the linkage between the output of the category classification AI and the analysis algorithm selection algorithm enables optimal analysis that responds to utterance content, contributing to improved analysis accuracy and user satisfaction. Specific application fields include automatic analysis of business meeting minutes, daily conversation support chatbots, and technical support automatic response. Variations of the embodiment include simultaneous analysis of multiple categories, personalization of category criteria for each user, and large-scale utterance analysis via cloud distributed processing.

The analysis unit can estimate the emotion of a user and determine a priority of analysis based on the estimated emotion of the user. The analysis unit may, for example, estimate the emotion of the user. The emotion may include, for example, tension, relaxation, urgency, but is not limited to such examples. The analysis unit may estimate the emotion of the user using facial expression analysis technology. The analysis unit may also estimate the emotion of the user using voice analysis technology. Furthermore, the analysis unit determines a priority of analysis based on the estimated emotion of the user. For example, if the user is tense, important utterances are preferentially analyzed. If the user is relaxed, utterances on light topics may be preferentially analyzed. If the user is in a hurry, utterances requiring prompt response may be preferentially analyzed. By determining a priority of analysis according to the user's emotion, important utterances can be preferentially analyzed. Emotion estimation is realized using, for example, an emotion engine or generative AI with emotion estimation functionality. The generative AI may be, for example, a text generative AI (e.g., LLM) or a multimodal generative AI, but is not limited to such examples. Some or all of the above-described processing in the analysis unit may be performed using AI, or may be performed without using AI. For example, the analysis unit may input the user's emotion data to the generative AI and have the generative AI determine a priority of analysis. Specifically, the analysis unit simultaneously acquires the user's facial image data (e.g., RGB image, resolution 128×128 pixels), audio waveform data (e.g., 16 kHz sampling, 1-5 seconds audio clip), and utterance text data (e.g., natural language sentences of 20-200 tokens), and preprocesses these using a multimodal feature extractor (e.g., CNN-based facial feature extraction network, acoustic feature extractor, BERT-based text embedding model). The analysis unit integrates the extracted features (e.g., 256-dimensional facial feature vector, 128-dimensional acoustic feature vector, 768-dimensional text embedding vector) and inputs them into a multimodal emotion estimation model (e.g., Transformer-type, with self-attention mechanism, 6 layers, hidden layer size 512). Examples of input to the AI include (1) a facial image of the user frowning plus utterance text “I'm busy today” plus low-pitched voice waveform, and (2) a facial image of the user smiling plus utterance text “I'm looking forward to it” plus high-pitched voice waveform. The analysis unit outputs emotion labels (e.g., “tension,” “relaxation,” “urgency,” etc.) and emotion scores (probability values from 0 to 1) from these inputs. For example, for input (1), the label “tension” (score 0.78) may be output, and for input (2), the label “relaxation” (score 0.85) may be output. The analysis unit applies an analysis priority determination algorithm (e.g., threshold judgment plus rule-based branching) based on the output emotion label and score, and dynamically controls the priority, such as prioritizing important utterances when the “tension” score is high, prioritizing light topics when the “relaxation” score is high, and prioritizing utterances requiring prompt response when the “urgency” score is high. The AI outputs structured data such as (1) analysis priority score for each utterance (0 to 1), and (2) priority analysis label (e.g., “highest priority,” “normal,” “deferred”). For example, important business communication utterances are labeled “highest priority,” and casual conversation utterances are labeled “normal.” In subsequent processing, the analysis unit dynamically controls the order and resource allocation of the utterance analysis pipeline based on the priority determination result, and sequentially accumulates the user's selection history as learning data. As a technical effect, the present invention not only automates human emotion observation and analysis prioritization, but also achieves highly accurate and flexible determination of utterance analysis priority tailored to the user's psychological state and situation by combining integrated analysis of multimodal high-dimensional features and dynamic priority control by AI, surpassing conventional static rule-based analysis. In terms of causality, the linkage between the output of the emotion estimation AI and the priority determination algorithm enables priority analysis of important utterances that responds to changes in the user's state, contributing to improved communication efficiency and reduction of misunderstandings and oversights. Specific application fields include customer support automatic response, remote medical interview analysis, educational support chatbots, and stress management support tools. Variations of the embodiment include methods that use biometric sensor data (heart rate, skin potential, etc.) from wearable devices as additional input, real-time video analysis for emotion estimation, large-scale user support via cloud collaboration, and simultaneous priority optimization for multiple users.

The analysis unit can set a priority of analysis based on a submission timing of the utterance at the time of analyzing the utterance. The analysis unit may, for example, determine the priority of analysis considering the submission timing of the utterance. The submission timing may include, for example, a timestamp or submission date and time, but is not limited to such examples. The analysis unit may preferentially analyze recently submitted utterances. The analysis unit may also preferentially analyze urgent utterances. Furthermore, the analysis unit may defer analysis of older utterances. By determining the priority of analysis based on the submission timing of the utterance, urgent utterances can be preferentially analyzed. Some or all of the above-described processing in the analysis unit may be performed using generative AI, or may be performed without using generative AI. For example, the analysis unit may input the submission timing of the utterance to the generative AI and have the generative AI determine the priority of analysis. Specifically, the analysis unit receives timestamp assigned to each utterance (e.g., UNIX epoch seconds, ISO8601 format date-time string), submission date-time metadata, and urgency tag of the utterance (e.g., “normal,” “urgent”) as input data. The analysis unit preprocesses these time-series information using a feature extractor (e.g., normalization of submission time, vectorization of elapsed time, one-hot vectorization of urgency) to generate a submission timing feature vector (e.g., 64 dimensions) for each utterance. The analysis unit integrates the submission timing feature vector and utterance content features (e.g., utterance category, importance score, etc.) and inputs them into a priority determination AI model (e.g., MLP-type 3-layer network, hidden layer 256, ReLU activation). Examples of input to the AI include (1) “Submission time: 2024 Jan. 1 T10:00:00Z+urgency: normal+utterance content: business communication,” (2) “Submission time: 2024 Jun. 1 T10:05:00Z+urgency: urgent+utterance content: failure report,” and (3) “Submission time: 2024 May 31 T18:00:00Z+urgency: normal+utterance content: casual conversation.” The AI outputs structured data such as (1) analysis priority score (0 to 1), and (2) priority analysis label (e.g., “highest priority,” “normal,” “deferred”) from these inputs. For example, utterances with high urgency and recent submission time are labeled “highest priority,” normal business communication is labeled “normal,” and older casual conversation is labeled “deferred.” In subsequent processing, the analysis unit dynamically controls the order and resource allocation of the utterance analysis pipeline based on the priority determination result, and sequentially accumulates the user's selection history and analysis results as learning data. As a technical effect, the present invention not only automates human management of submission timing and prioritization, but also achieves highly accurate and flexible determination of utterance analysis priority tailored to submission timing, urgency, and content by combining integrated analysis of high-dimensional time-series features by AI and dynamic priority control, surpassing conventional static rule-based analysis. In terms of causality, the linkage between AI analysis of submission timing features and the analysis unit enables analysis that responds to the user's latest utterances and urgent utterances, contributing to improved communication efficiency and reduction of misunderstandings and oversights. Specific application fields include customer support automatic response, emergency reporting systems, business communication analysis, and educational support chatbots. Variations of the embodiment include simultaneous optimization of submission timing for multiple users, real-time re-evaluation of submission timing, and large-scale utterance priority analysis via cloud distributed processing.

The analysis unit can set an order of analysis based on a relevance of the utterance at the time of analyzing the utterance. The analysis unit may, for example, evaluate the relevance of the utterance. The relevance may include, for example, degree of content match or common topics, but is not limited to such examples. The analysis unit may preferentially analyze utterances with high relevance. The analysis unit may also defer analysis of utterances with low relevance. Furthermore, the analysis unit may dynamically adjust the order of analysis according to the relevance of the utterance. By adjusting the order of analysis based on the relevance of the utterance, utterances with high relevance can be preferentially analyzed. Some or all of the above-described processing in the analysis unit may be performed using generative AI, or may be performed without using generative AI. For example, the analysis unit may input the relevance of the utterance to the generative AI and have the generative AI adjust the order of analysis. Specifically, the analysis unit receives content features for each utterance (e.g., topic distribution vector, keyword occurrence vector, utterance category label), relevance score between utterances (e.g., cosine similarity, Jaccard coefficient, number of common topics), and utterance history information (e.g., immediately preceding and following utterance ID, conversation thread ID, etc.) as input data. The analysis unit preprocesses these features using a feature extractor (e.g., BERT-based embedding model, topic estimator, similarity calculation module) to generate a relevance feature vector (e.g., 128 dimensions) for each utterance. The analysis unit applies an analysis order determination AI model (e.g., MLP-type 3-layer network, hidden layer 256, ReLU activation) using the relevance feature vector as input. Examples of input to the AI include (1) “Utterance A: business communication +Utterance B: delivery date adjustment+topic similarity 0.92,” (2) “Utterance A: casual conversation+Utterance B: weekend plans+topic similarity 0.35,” and (3) “Utterance A: failure report+Utterance B: system recovery+topic similarity 0.88.” The AI outputs structured data such as (1) analysis order score (0 to 1), and (2) priority analysis label (e.g., “highest priority,” “normal,” “deferred”) from these inputs. For example, utterance pairs with high topic similarity are labeled “highest priority,” and utterances with low relevance are labeled “deferred.” In subsequent processing, the analysis unit dynamically controls the order and resource allocation of the utterance analysis pipeline based on the analysis order determination result, and sequentially accumulates the user's selection history and analysis results as learning data. As a technical effect, the present invention not only automates human judgment of utterance relevance and ordering, but also achieves highly accurate and flexible determination of utterance analysis order tailored to utterance content, topic, and conversation structure by combining integrated analysis of high-dimensional content features and relevance scores by AI and dynamic order control, surpassing conventional static rule-based analysis. In terms of causality, the linkage between AI analysis of relevance features and the analysis unit enables analysis that responds to the user's conversation flow and important topics, contributing to improved communication efficiency and reduction of misunderstandings and oversights. Specific application fields include automatic analysis of business meeting minutes, customer support automatic response, educational support chatbots, and SNS conversation analysis. Variations of the embodiment include simultaneous analysis of multiple topics, real-time re-evaluation of relevance, and large-scale optimization of utterance order via cloud distributed processing.

The proposal unit can estimate the emotion of a user and adjust an expression method of the proposal based on the estimated emotion of the user. The proposal unit may, for example, estimate the emotion of the user. The emotion may include, for example, tension, relaxation, urgency, but is not limited to such examples. The proposal unit may estimate the emotion of the user using facial expression analysis technology. The proposal unit may also estimate the emotion of the user using voice analysis technology. Furthermore, the proposal unit adjusts the expression method of the proposal based on the estimated emotion of the user. For example, if the user is tense, a simple and easy-to-understand expression method is proposed. If the user is relaxed, an expression method including detailed information may be proposed. If the user is in a hurry, an expression method that can be quickly understood may be proposed. By adjusting the expression method of the proposal according to the user's emotion, more appropriate proposals can be made. Emotion estimation is realized using, for example, an emotion engine or generative AI with emotion estimation functionality. The generative AI may be, for example, a text generative AI (e.g., LLM) or a multimodal generative AI, but is not limited to such examples. Some or all of the above-described processing in the proposal unit may be performed using AI, or may be performed without using AI. For example, the proposal unit may input the user's emotion data to the generative AI and have the generative AI adjust the expression method of the proposal. Specifically, the proposal unit simultaneously acquires the user's facial image data (e.g., RGB image, resolution 128×128 pixels), audio waveform data (e.g., 16 kHz sampling, 1-5 seconds audio clip), and utterance text data (e.g., natural language sentences of 20-200 tokens), and preprocesses these using a multimodal feature extractor (e.g., CNN-based facial feature extraction network, acoustic feature extractor, BERT-based text embedding model). The proposal unit integrates the extracted features (e.g., 256-dimensional facial feature vector, 128-dimensional acoustic feature vector, 768-dimensional text embedding vector) and inputs them into a multimodal emotion estimation model (e.g., Transformer-type, with self-attention mechanism, 6 layers, hidden layer size 512). Examples of input to the AI include (1) a facial image of the user frowning plus utterance text “I'm busy today” plus low-pitched voice waveform, and (2) a facial image of the user smiling plus utterance text “I'm looking forward to it” plus high-pitched voice waveform. The AI outputs emotion labels (e.g., “tension,” “relaxation,” “urgency,” etc.) and emotion scores (probability values from 0 to 1) from these inputs. For example, for input (1), the label “tension” (score 0.78) may be output, and for input (2), the label “relaxation” (score 0.85) may be output. The proposal unit applies an expression method selection algorithm (e.g., threshold judgment plus rule-based branching) based on the output emotion label and score, and automatically selects the expression method, such as simple expression using short sentences, bullet points, and plain vocabulary when the “tension” score is high, rich expression including detailed explanations, supplementary information, and examples when the “relaxation” score is high, and concise expression extracting only key points when the “urgency” score is high. The AI outputs structured data such as (1) expression method label (e.g., “simple,” “detailed,” “concise”), and (2) expression parameter set (e.g., sentence length constraint, vocabulary level, number of explanation stages, etc.). For example, in the “tension” state, “simple” label plus sentence length 30 tokens is output; in the “relaxation” state, “detailed” label plus sentence length 100 tokens; and in the “urgency” state, “concise” label plus only 3 key points. In subsequent processing, the proposal unit dynamically switches the proposal generation pipeline according to the selected expression method, presents the generated proposal to the user, and sequentially accumulates the user's reaction history as learning data. As a technical effect, the present invention not only automates human emotion observation and selection of expression method, but also achieves highly accurate and flexible selection of proposal expression method tailored to the user's psychological state and situation by combining integrated analysis of multimodal high-dimensional features and dynamic expression control by AI, surpassing conventional static rule-based proposals. In terms of causality, the linkage between the output of the emotion estimation AI and the expression method selection algorithm enables optimal proposal presentation that responds to changes in the user's state, contributing to improved proposal comprehension and user satisfaction. Specific application fields include customer support automatic response, educational support chatbots, stress management support tools, and medical interview support. Variations of the embodiment include methods that use biometric sensor data (heart rate, skin potential, etc.) from wearable devices as additional input, real-time video analysis for emotion estimation, large-scale user support via cloud collaboration, and simultaneous optimization of expression methods for multiple users.

The proposal unit can set a level of detail of the proposal based on an importance of the utterance at the time of making the proposal. The proposal unit may, for example, evaluate the importance of the utterance. The importance may include, for example, the content or impact of the utterance, but is not limited to such examples. The proposal unit may provide detailed proposals for important utterances. The proposal unit may also provide simplified proposals for utterances on light topics. Furthermore, the proposal unit may provide proposals that enable rapid response for urgent utterances. By adjusting the level of detail of the proposal based on the importance of the utterance, detailed proposals can be provided for important utterances. Some or all of the above-described processing in the proposal unit may be performed using generative AI, or may be performed without using generative AI. For example, the proposal unit may input the importance of the utterance to the generative AI and have the generative AI adjust the level of detail of the proposal. Specifically, the proposal unit receives utterance content features (e.g., keyword occurrence frequency, utterance category, past impact score, urgency tag, etc.) as input data. The proposal unit preprocesses these features using a feature extractor (e.g., TF-IDF vectorization, category one-hot encoding, urgency vectorization) to generate an importance feature vector (e.g., 64 dimensions) for each utterance. The proposal unit applies a detail determination AI model (e.g., MLP-type 3-layer network, hidden layer 256, ReLU activation) using the importance feature vector as input. Examples of input to the AI include (1) “Business communication: notification of delivery date change+impact score 0.9,” (2) “Casual conversation: weekend plans+impact score 0.2,” and (3) “Urgent: system failure report+urgency tag ‘high.’” The AI outputs structured data such as (1) proposal detail label (e.g., “detailed,” “simple,” “fast”), and (2) proposal parameter set (e.g., number of explanation stages, sentence length constraint, number of key points, etc.). For example, for an utterance with impact score 0.9, “detailed” label plus 3 explanation stages is output; for an utterance with score 0.2, “simple” label plus 1 explanation stage; and for an utterance with urgency “high,” “fast” label plus only key points. In subsequent processing, the proposal unit dynamically switches the proposal generation pipeline according to the selected level of detail, presents the generated proposal to the user, and sequentially accumulates the user's reaction history as learning data. As a technical effect, the present invention not only automates human judgment of utterance importance and selection of proposal detail, but also achieves highly accurate and flexible selection of proposal detail tailored to utterance content, impact, and urgency by combining integrated analysis of high-dimensional features by AI and dynamic proposal pipeline control, surpassing conventional static rule-based proposals. In terms of causality, the linkage between the output of the importance estimation AI and the proposal detail control algorithm enables optimal proposals for important or urgent utterances, contributing to improved proposal accuracy and faster response. Specific application fields include automatic proposal for business communication, emergency reporting systems, educational support chatbots, and customer support automatic response. Variations of the embodiment include personalization of importance criteria for each user, real-time re-evaluation of importance, and large-scale proposal generation via cloud distributed processing.

The proposal unit can use different proposal algorithms according to the category of the utterance at the time of making a proposal. For example, the proposal unit identifies the category of the utterance. Categories may include, for example, business-related, daily conversation, technical utterances, and the like, but are not limited thereto. For business-related utterances, the proposal unit applies a business-specific proposal algorithm. For daily conversation utterances, a daily conversation-specific proposal algorithm may be applied. Furthermore, for technical utterances, a technical proposal algorithm may be applied. By applying different proposal algorithms according to the category of the utterance, more appropriate proposals can be made. Some or all of the above-described processing in the proposal unit may be performed using generative AI, or may be performed without using generative AI. For example, the proposal unit may input the category of the utterance to generative AI and have the generative AI execute the application of the proposal algorithm. Specifically, the proposal unit receives utterance content feature quantities (e.g., keyword distribution vectors, topic distribution vectors, past category labels, etc.) as input data. The proposal unit preprocesses these feature quantities using a feature extractor (e.g., BERT-based embedding model, topic estimator) and generates a category feature vector (e.g., 128 dimensions) for each utterance. The proposal unit applies a category classification AI model (e.g., BERT-based text classification model, hidden layer size 768, 12 layers) that takes the category feature vector as input and outputs a category label (e.g., “business,” “daily conversation,” “technical,” etc.) and a category score (0 to 1) for each utterance. Examples of AI input include (1) “meeting minutes” text, (2) “weekend plans” text, and (3) “introduction of new technology” text. The AI outputs (1) proposal algorithm selection label (e.g., “business,” “daily conversation,” “technical”), and (2) proposal parameter set (e.g., model ID used, number of explanation stages, etc.). For example, the “meeting minutes” input selects the “business” algorithm, “weekend plans” selects the “daily conversation” algorithm, and “introduction of new technology” selects the “technical” algorithm. In subsequent processing, the proposal unit dynamically switches the proposal generation pipeline according to the selected proposal algorithm, presents the generated proposal to the user, and sequentially accumulates the user's reaction history as learning data. As a technical effect, the present invention not only automates human category judgment and proposal algorithm selection, but also combines high-dimensional feature integration analysis and dynamic algorithm selection control by AI, thereby achieving high-precision and flexible proposal algorithm selection tailored to utterance categories, which is superior to conventional static rule-based proposals. In terms of causality, the linkage between the output of the category classification AI and the proposal algorithm selection algorithm enables optimal proposals that respond to utterance content, contributing to improved proposal accuracy and user satisfaction. Specific application fields include automatic proposal for business meetings, daily conversation support chatbots, and technical support automatic response. Variations of the embodiment include simultaneous proposals for multiple categories, personalized category criteria for each user, and large-scale proposal generation by cloud distributed processing.

The proposal unit can estimate the emotion of a user and adjust the length of the proposal based on the estimated emotion. For example, the proposal unit estimates the emotion of the user. Emotions may include, for example, tension, relaxation, being in a hurry, and the like, but are not limited thereto. The proposal unit may use facial expression analysis technology to estimate the user's emotion. The proposal unit may also use voice analysis technology to estimate the user's emotion. Furthermore, the proposal unit adjusts the length of the proposal based on the estimated emotion of the user. For example, if the user is tense, a short and concise proposal is made. If the user is relaxed, a longer proposal including detailed explanations may be made. If the user is in a hurry, a short proposal that can be quickly understood may be made. By adjusting the length of the proposal according to the user's emotion, more appropriate proposals can be made. Emotion estimation may be realized using an emotion engine or generative AI, such as a text generation AI (e.g., LLM) or multimodal generative AI, but is not limited thereto. Some or all of the above-described processing in the proposal unit may be performed using AI, or may be performed without using AI. For example, the proposal unit may input the user's emotion data to generative AI and have the generative AI execute the adjustment of the proposal length. Specifically, the proposal unit simultaneously acquires the user's facial image data (e.g., RGB image, resolution 128×128 pixels), voice waveform data (e.g., 16 kHz sampling, 1-5 seconds audio clip), and utterance text data (e.g., 20-200 tokens of natural language sentences), and preprocesses these using a multimodal feature extractor (e.g., CNN-based facial feature extraction network, acoustic feature extractor, BERT-based text embedding model). The proposal unit integrates the extracted feature quantities (e.g., facial feature vector 256 dimensions, acoustic feature vector 128 dimensions, text embedding vector 768 dimensions) and inputs them to a multimodal emotion estimation model (e.g., Transformer type, with self-attention mechanism, 6 layers, hidden layer size 512). Examples of AI input include (1) “facial image of user frowning+utterance text ‘I'm busy today’+low-pitched voice waveform,” (2) “facial image of user smiling +utterance text ‘I'm looking forward to it’+high-pitched voice waveform,” and so on. The AI outputs emotion labels (e.g., “tense,” “relaxed,” “in a hurry,” etc.) and emotion scores (probability values from 0 to 1). For example, input (1) may output a “tense” label (score 0.78), and input (2) may output a “relaxed” label (score 0.85). Based on the output emotion label and score, the proposal unit applies a proposal length determination algorithm (e.g., threshold judgment+rule-based branching), and automatically selects a short proposal within 30 tokens for high “tense” scores, a detailed proposal of 100 tokens or more for high “relaxed” scores, and a concise proposal with only key points for high “in a hurry” scores. The AI output is structured data such as (1) proposal length label (e.g., “short,” “long,” “key points only”), and (2) length parameters (e.g., sentence length constraint, number of key points, etc.). For example, in a “tense” state, a “short” label+sentence length 30 tokens; in a “relaxed” state, a “long” label+sentence length 100 tokens; in an “in a hurry” state, a “key points only” label+3 key points are output. In subsequent processing, the proposal unit dynamically switches the proposal generation pipeline according to the selected length, presents the generated proposal to the user, and sequentially accumulates the user's reaction history as learning data. As a technical effect, the present invention not only automates human emotion observation and proposal length selection, but also combines multimodal high-dimensional feature integration analysis and dynamic length control by AI, thereby achieving high-precision and flexible proposal length selection tailored to the user's psychological state and situation, which is superior to conventional static rule-based proposals. In terms of causality, the linkage between the output of the emotion estimation AI and the length determination algorithm enables optimal proposal presentation that responds to changes in the user's state, contributing to improved proposal comprehension and user satisfaction. Specific application fields include automatic response for customer support, educational support chatbots, stress management support tools, and medical interview support. Variations of the embodiment include methods that use biometric sensor data (heart rate, skin potential, etc.) from wearable devices as additional input, real-time video analysis for emotion estimation, large-scale user support via cloud collaboration, and simultaneous length optimization for multiple users.

The proposal unit can set the priority of proposals based on the submission timing of the utterance at the time of making a proposal. For example, the proposal unit determines the priority of proposals by considering the submission timing of the utterance. Submission timing may include, for example, timestamps or submission dates, but is not limited thereto. The proposal unit may prioritize proposals for recently submitted utterances. The proposal unit may also prioritize proposals for urgent utterances. Furthermore, proposals for older utterances may be postponed. By determining the priority of proposals based on the submission timing of the utterance, proposals for urgent utterances can be prioritized. Some or all of the above-described processing in the proposal unit may be performed using generative AI, or may be performed without using generative AI. For example, the proposal unit may input the submission timing of the utterance to generative AI and have the generative AI execute the determination of proposal priority. Specifically, the proposal unit receives, as input data, timestamps assigned to each utterance (e.g., UNIX epoch seconds, ISO8601 format date-time strings), submission date metadata, and urgency tags for the utterance (e.g., “normal,” “urgent”). The proposal unit preprocesses these time-series information using a feature extractor (e.g., normalization of submission time, vectorization of elapsed time, one-hot vectorization of urgency) and generates a submission timing feature vector (e.g., 64 dimensions) for each utterance. The proposal unit integrates the submission timing feature vector and utterance content feature quantities (e.g., utterance category, importance score, etc.), and inputs them to a priority determination AI model (e.g., MLP-type 3-layer network, hidden layer 256, ReLU activation). Examples of AI input include (1) “submission time: 2024 Jun. 1 T10:00:00 Z+urgency: normal+utterance content: business communication,” (2) “submission time: 2024 Jun. 1 T10:05:00 Z+urgency: urgent+utterance content: incident report,” (3) “submission time: 2024 May 31 T18:00:00 Z+urgency: normal+utterance content: casual conversation,” and so on. The AI outputs (1) proposal priority score (0 to 1), and (2) priority proposal label (e.g., “highest priority,” “normal,” “postponed”) as structured data. For example, utterances with high urgency and recent submission time are labeled “highest priority,” normal business communications are labeled “normal,” and older casual conversations are labeled “postponed.” In subsequent processing, the proposal unit dynamically controls the order and resource allocation of the proposal generation pipeline based on the priority results, and sequentially accumulates the user's selection history and proposal results as learning data. As a technical effect, the present invention not only automates human management of submission timing and priority assignment, but also combines high-dimensional time-series feature integration analysis and dynamic priority control by AI, thereby achieving high-precision and flexible proposal priority determination tailored to submission timing, urgency, and content, which is superior to conventional static rule-based proposals. In terms of causality, the linkage between AI analysis of submission timing features and the proposal unit enables proposals that respond to the user's latest utterances and urgent utterances, contributing to improved communication efficiency and reduction of misunderstandings and oversights. Specific application fields include automatic response for customer support, emergency notification systems, business communication proposals, and educational support chatbots. Variations of the embodiment include simultaneous optimization of submission timing for multiple users, real-time re-evaluation of submission timing, and large-scale proposal priority analysis by cloud distributed processing.

The proposal unit can set the order of proposals based on the relevance of the utterance at the time of making a proposal. For example, the proposal unit evaluates the relevance of the utterance. Relevance may include, for example, content matching or common topics, but is not limited thereto. The proposal unit may prioritize proposals for utterances with high relevance. Proposals for utterances with low relevance may be postponed. Furthermore, the proposal unit can dynamically adjust the order of proposals according to the relevance of the utterance. By adjusting the order of proposals based on the relevance of the utterance, proposals for utterances with high relevance can be prioritized. Some or all of the above-described processing in the proposal unit may be performed using generative AI, or may be performed without using generative AI. For example, the proposal unit may input the relevance of the utterance to generative AI and have the generative AI execute the adjustment of proposal order. Specifically, the proposal unit receives, as input data, content feature quantities for each utterance (e.g., topic distribution vector, keyword occurrence vector, utterance category label), relevance score between utterances (e.g., cosine similarity, Jaccard coefficient, number of common topics), and utterance history information (e.g., previous/next utterance ID, conversation thread ID, etc.). The proposal unit preprocesses these feature quantities using a feature extractor (e.g., BERT-based embedding model, topic estimator, similarity calculation module) and generates a relevance feature vector (e.g., 128 dimensions) for each utterance. The proposal unit applies a proposal order determination AI model (e.g., MLP-type 3-layer network, hidden layer 256, ReLU activation) that takes the relevance feature vector as input. Examples of AI input include (1) “Utterance A: business communication+Utterance B: delivery adjustment+topic similarity 0.92,” (2) “Utterance A: casual conversation+Utterance B: weekend plans+topic similarity 0.35,” (3) “Utterance A: incident report+Utterance B: system recovery+topic similarity 0.88,” and so on. The AI outputs (1) proposal order score (0 to 1), and (2) priority proposal label (e.g., “highest priority,” “normal,” “postponed”) as structured data. For example, utterance pairs with high topic similarity are labeled “highest priority,” and utterances with low relevance are labeled “postponed.” In subsequent processing, the proposal unit dynamically controls the order and resource allocation of the proposal generation pipeline based on the proposal order results, and sequentially accumulates the user's selection history and proposal results as learning data. As a technical effect, the present invention not only automates human judgment of utterance relevance and ordering, but also combines high-dimensional content feature and relevance score integration analysis and dynamic order control by AI, thereby achieving high-precision and flexible proposal order determination tailored to utterance content, topic, and conversation structure, which is superior to conventional static rule-based proposals. In terms of causality, the linkage between AI analysis of relevance features and the proposal unit enables proposals that respond to the flow of conversation and important topics, contributing to improved communication efficiency and reduction of misunderstandings and oversights. Specific application fields include automatic proposal for business meetings, automatic response for customer support, educational support chatbots, and SNS conversation proposals. Variations of the embodiment include simultaneous proposals for multiple topics, real-time re-evaluation of relevance, and large-scale proposal order optimization by cloud distributed processing.

The system according to the embodiment is not limited to the above examples, and various modifications are possible, for example, as described below. Specifically, the system can flexibly change the module configuration of the receiving unit, analysis unit, and proposal unit, as well as the architecture of the AI models. For example, in the receiving unit, multimodal input expansion for voice, image, text, biometric sensors, etc., distributed reception via cloud collaboration, and support for simultaneous reception from multiple users are possible. In the analysis unit, various variations are conceivable, such as changing the number of layers, hidden layer size, and self-attention mechanism parameters of Transformer-based large language models, hybrid configurations with LSTM-based time-series models and CNN-based feature extraction networks, support for specialized domains via external knowledge base collaboration, switching between real-time and batch inference, and stepwise optimization of the analysis pipeline. In the proposal unit, rule-based and AI-hybrid proposal generation, personalized proposals for each user, multilingual support, automatic summarization and detailing of proposal content, group proposal optimization, and sequential accuracy improvement through user feedback learning can be realized. Furthermore, as a whole system, various embodiments are possible according to advances in computer technology, such as large-scale operation on a cloud distributed processing platform, low-latency response via edge device collaboration, secure data management and access control, external service expansion via API collaboration, and addition of anomaly detection and automatic fault recovery functions. These modifications enable the system to be optimized for specific applications and operating environments, and technical effects such as improved processing speed, enhanced analysis accuracy, reduced operating costs, improved user experience, strengthened security, and enhanced scalability can be obtained. Application fields include business negotiation support, automation of medical, educational, administrative, and customer support, IoT collaboration services, cross-cultural communication support, stress management support, and a wide range of other fields.

The receiving unit can analyze the user's past utterance history and learn the user's preferences and tendencies. For example, words and phrases frequently used by the user in the past are identified, and utterance reception is optimized based on them. If the user shows strong interest in a particular topic, utterances related to that topic can be preferentially received. Furthermore, the user's utterance patterns can be analyzed to select the optimal reception timing. By utilizing the user's past utterance history, more personalized utterance reception can be realized. Specifically, the receiving unit maintains a time-series database of more than 100 past utterance history records for each user (e.g., utterance text sequence, utterance time, utterance format tag (voice/text), utterance length, utterance category, etc.). The receiving unit extracts features from the utterance history (e.g., utterance frequency vector, utterance format one-hot vector, topic distribution vector, utterance timing histogram, etc.) and applies a history analysis AI model (e.g., LSTM-based time-series model, hidden layer size 256, 3 layers) using these as input. Examples of AI input include (1) “utterance text sequence for the past 30 days+utterance time+utterance format tag,” (2) “topic distribution vector frequently used in the past+utterance length histogram,” (3) “usage frequency vector for each utterance category,” and so on. The AI outputs (1) optimal reception format (e.g., voice priority, text priority), (2) optimal reception timing (e.g., morning priority, night priority), and (3) priority score for related utterances (0 to 1) as structured data. For example, if the user has frequently used voice utterances in the past, the system recommends “voice priority” reception format, and if there are many utterances on a particular topic, utterances related to that topic are preferentially received. In subsequent processing, the receiving unit dynamically switches the display order and reception mode of the reception UI based on the AI output, and sequentially accumulates the user's selection history as learning data. As a technical effect, the present invention not only automates the recording of utterance history and human selection of reception methods, but also integrates high-dimensional history feature time-series analysis and reception control by AI, thereby achieving high-precision and flexible reception method selection optimized for each user, which is superior to conventional static reception methods. In terms of causality, the linkage between the output of the history analysis AI and the dynamic control of the receiving unit enables reception that responds to the user's utterance tendencies and usage patterns, contributing to improved user experience and optimized reception efficiency. Specific application fields include customer support reception systems, educational support chatbots, medical interview reception terminals, and personal assistants. Variations of the embodiment include recommendation of reception methods by clustering using group history of multiple users, sequential optimization by real-time history updates, and large-scale history analysis by cloud distributed processing.

The analysis unit can analyze non-verbal elements contained in the user's utterance. For example, it analyzes the tone, speed, and pauses in the utterance to more accurately read the user's emotion and intention. By analyzing the user's facial expressions and gestures, it can also supplement the emotion and intention behind the utterance. Furthermore, it can learn the user's past non-verbal behavior patterns and improve the accuracy of utterance analysis based on them. Thus, utterance analysis that takes non-verbal elements into account can be realized. Specifically, the analysis unit simultaneously acquires the user's voice waveform data (e.g., 16 kHz sampling, 1-5 seconds audio clip), facial image data (e.g., RGB image, resolution 128×128 pixels), gesture video data (e.g., 30 fps, 2 seconds video), and utterance text data (e.g., 20-200 tokens of natural language sentences), and preprocesses these using a multimodal feature extractor (e.g., CNN-based facial feature extraction network, acoustic feature extractor, pose estimation network, BERT-based text embedding model). The analysis unit integrates the extracted feature quantities (e.g., acoustic feature vector 128 dimensions, facial feature vector 256 dimensions, gesture feature vector 64 dimensions, text embedding vector 768 dimensions) and inputs them to a multimodal non-verbal analysis model (e.g., Transformer type, with self-attention mechanism, 8 layers, hidden layer size 512). Examples of AI input include (1) “low-pitched voice+slow speech rate+frowning facial expression+hand-gripping gesture+utterance text ‘I'm busy today’,” (2) “high-pitched voice+fast speech+smiling face+hand-spreading gesture+utterance text ‘I'm looking forward to it’,” and so on. The AI outputs (1) emotion label (e.g., “tense,” “excited,” “fatigued,” etc.), (2) intention label (e.g., “serious,” “social courtesy,” etc.), and (3) non-verbal feature score (0 to 1) as structured data. For example, input (1) may output “tense” label (score 0.78)+“serious” intention, “low-pitched voice” feature score 0.85; input (2) may output “excited” label (score 0.92)+“social courtesy” intention, “smiling” feature score 0.88. In subsequent processing, the analysis unit dynamically controls the branching and analysis depth of the utterance analysis pipeline based on the output emotion, intention, and non-verbal feature score, and sends the analysis results to the proposal unit. As a technical effect, the present invention not only automates human non-verbal observation and emotion estimation, but also combines multimodal high-dimensional feature integration analysis and dynamic analysis pipeline control by AI, thereby achieving high-precision and flexible utterance analysis tailored to the user's psychological state and intention, which is superior to conventional static rule-based analysis. In terms of causality, the linkage between AI analysis of non-verbal features and the analysis unit enables analysis that responds to changes in the user's state and hidden intentions behind utterances, contributing to reduced misunderstandings in communication and improved analysis accuracy. Specific application fields include automatic response for customer support, remote medical interview analysis, educational support chatbots, stress management support tools, and interview evaluation support. Variations of the embodiment include methods that use biometric sensor data (heart rate, skin potential, etc.) from wearable devices as additional input, real-time video analysis for non-verbal estimation, large-scale user support via cloud collaboration, and simultaneous optimization of non-verbal analysis for multiple users.

The proposal unit can adjust the proposal content based on the user's current activity status. For example, if the user is exercising, a short and concise proposal is made. If the user is relaxing, a proposal including detailed information may be made. Furthermore, if the user is working, a specific proposal related to work may be made. Thus, appropriate proposals tailored to the user's current activity status can be realized. Specifically, the proposal unit acquires the user's current activity status data (e.g., activity sensor data (acceleration, heart rate), device usage log, calendar schedule information, location information, etc.), preprocesses these using a feature extractor (e.g., time-series vectorization of activity sensor data, one-hot vectorization of schedule information, vectorization of location information), and generates an integrated activity feature vector (e.g., 256 dimensions). The proposal unit applies an activity status adaptation AI model (e.g., MLP-type 3-layer network, hidden layer 256, ReLU activation) that takes the integrated activity feature vector as input. Examples of AI input include (1) “activity: exercising+heart rate 120 bpm+device: smartwatch+location: gym,” (2) “activity: relaxing+heart rate 70 bpm+device: tablet+location: home,” (3) “activity: working+calendar schedule: meeting+device: PC+location: office,” and so on. The AI outputs (1) proposal content type (e.g., “concise,” “detailed,” “work-specific”), and (2) proposal parameter set (e.g., sentence length constraint, number of key points, related topics, etc.). For example, during exercise, “concise” type+3 key points; during relaxation, “detailed” type+sentence length 100 tokens; during work, “work-specific” type+only related work topics are output. In subsequent processing, the proposal unit dynamically switches the proposal generation pipeline according to the selected proposal content type, presents the generated proposal to the user, and sequentially accumulates the user's reaction history as learning data. As a technical effect, the present invention not only automates human observation of activity status and selection of proposal content, but also combines multimodal and high-dimensional feature integration analysis and dynamic proposal content control by AI, thereby achieving high-precision and flexible proposal content selection tailored to the user's activity status, which is superior to conventional static rule-based proposals. In terms of causality, the linkage between AI analysis of activity status features and the proposal unit enables proposals that respond to the user's current state and activity, contributing to improved proposal comprehension and user satisfaction. Specific application fields include personal assistants, health management apps, automatic response for customer support, educational support chatbots, and business support tools. Variations of the embodiment include proposal control by real-time activity recognition, group proposal optimization considering the activity status of multiple users, and large-scale activity analysis via cloud collaboration.

The proposal unit can analyze the user's past proposal history and improve the accuracy of proposals. For example, it learns proposals that the user has accepted or rejected in the past and optimizes new proposals based on that. It can also analyze how the user responded to specific proposals and adjust proposal content in similar situations. Furthermore, based on the user's past proposal history, it can grasp the user's preferences and tendencies and make more personalized proposals. Thus, highly accurate proposals utilizing the user's past proposal history can be realized. Specifically, the proposal unit maintains a time-series database of more than 100 past proposal history records for each user (e.g., proposal content text, proposal time, proposal category, user's acceptance/rejection label, reaction content (e.g., feedback text, selection action), etc.). The proposal unit extracts features from the proposal history (e.g., acceptance rate vector, category-specific reaction histogram, proposal content embedding vector, reaction pattern distribution, etc.) and applies a history analysis AI model (e.g., LSTM-based time-series model, hidden layer size 256, 3 layers) using these as input. Examples of AI input include (1) “proposal content sequence for the past 30 days+acceptance/rejection label+reaction text,” (2) “category-specific acceptance rate vector+reaction pattern distribution,” (3) “proposal content embedding vector+past selection actions,” and so on. The AI outputs (1) optimal proposal content type (e.g., “detailed,” “simple,” “work-specific”), (2) proposal priority score (0 to 1), and (3) personalization parameter set (e.g., number of explanation stages, number of key points, etc.) as structured data. For example, if the user has a strong tendency to accept detailed proposals in the past, “detailed” type+3 explanation stages are output; if the user prefers simple proposals, “simple” type+only key points are output. In subsequent processing, the proposal unit dynamically switches the proposal generation pipeline and display order based on the AI output, and sequentially accumulates the user's reaction history as learning data. As a technical effect, the present invention not only automates the recording of proposal history and human selection of proposal content, but also integrates high-dimensional history feature time-series analysis and proposal control by AI, thereby achieving high-precision and flexible proposal content selection optimized for each user, which is superior to conventional static proposal methods. In terms of causality, the linkage between the output of the history analysis AI and the dynamic control of the proposal unit enables proposals that respond to the user's proposal acceptance tendencies and reaction patterns, contributing to improved user satisfaction and proposal accuracy. Specific application fields include automatic response for customer support, educational support chatbots, medical interview proposals, and personal assistants. Variations of the embodiment include recommendation of proposal methods by clustering using group history of multiple users, sequential optimization by real-time history updates, and large-scale history analysis by cloud distributed processing.

The receiving unit can estimate the emotion of a user and adjust the utterance receiving method based on the estimated emotion. For example, if the user is tense, a receiving method that helps the user relax is adopted. If the user is excited, the system may wait until the user calms down before receiving the utterance. Furthermore, if the user is fatigued, the system may receive the utterance after a break. Thus, appropriate utterance reception tailored to the user's emotion can be realized. Specifically, the receiving unit simultaneously acquires the user's facial image data (e.g., RGB image, resolution 128×128 pixels), voice waveform data (e.g., 16 kHz sampling, 1-5 seconds audio clip), and utterance text data (e.g., 20-200 tokens of natural language sentences), and preprocesses these using a multimodal feature extractor (e.g., CNN-based facial feature extraction network, acoustic feature extractor, BERT-based text embedding model). The receiving unit integrates the extracted feature quantities (e.g., facial feature vector 256 dimensions, acoustic feature vector 128 dimensions, text embedding vector 768 dimensions) and inputs them to a multimodal emotion estimation model (e.g., Transformer type, with self-attention mechanism, 6 layers, hidden layer size 512). Examples of AI input include (1) “facial image of user frowning+utterance text ‘I'm busy today’+low-pitched voice waveform,” (2) “facial image of user smiling+utterance text ‘I'm looking forward to it’+high-pitched voice waveform,” and so on. The AI outputs emotion labels (e.g., “tense,” “excited,” “fatigued,” etc.) and emotion scores (probability values from 0 to 1). For example, input (1) may output a “tense” label (score 0.78), and input (2) may output an “excited” label (score 0.85). Based on the output emotion label and score, the receiving unit applies an utterance reception timing control algorithm (e.g., threshold judgment+rule-based branching), and dynamically adjusts timing such as waiting for a certain period when the “tense” score is high, setting a cool-down time when the “excited” score is high, and resuming reception after a break when the “fatigued” score is high. In subsequent processing, the adjustment history of reception timing is recorded in a database, and optimization parameters for each user can be sequentially learned. As a technical effect, the present invention not only automates human emotion observation, but also combines multimodal high-dimensional feature integration analysis and dynamic timing control by AI, thereby achieving high-precision and flexible reception timing adjustment tailored to the user's psychological state, which is superior to conventional simple timer control or static rule-based reception. In terms of causality, the linkage between the output of the emotion estimation AI and the reception timing control algorithm enables reception that responds to changes in the user's state, contributing to smoother communication and reduced stress. Specific application fields include customer support reception terminals, remote medical interview systems, educational support chatbots, and stress management support tools. Variations of the embodiment include methods that use biometric sensor data (heart rate, skin potential, etc.) from wearable devices as additional input, real-time video analysis for emotion estimation, and large-scale user support via cloud collaboration.

The analysis unit can estimate the emotion contained in the user's utterance and adjust the level of detail of analysis based on the estimated emotion. For example, if the user is tense, a simple analysis method is applied. If the user is relaxed, a detailed analysis method may be applied. Furthermore, if the user is in a hurry, a method that provides analysis results quickly may be applied. Thus, appropriate utterance analysis tailored to the user's emotion can be realized. Specifically, the analysis unit simultaneously acquires the user's facial image data (e.g., RGB image, resolution 128×128 pixels), voice waveform data (e.g., 16 kHz sampling, 1-5 seconds audio clip), and utterance text data (e.g., 20-200 tokens of natural language sentences), and preprocesses these using a multimodal feature extractor (e.g., CNN-based facial feature extraction network, acoustic feature extractor, BERT-based text embedding model). The analysis unit integrates the extracted feature quantities (e.g., facial feature vector 256 dimensions, acoustic feature vector 128 dimensions, text embedding vector 768 dimensions) and inputs them to a multimodal emotion estimation model (e.g., Transformer type, with self-attention mechanism, 6 layers, hidden layer size 512). Examples of AI input include (1) “facial image of user frowning+utterance text ‘I'm busy today’+low-pitched voice waveform,” (2) “facial image of user smiling+utterance text ‘I'm looking forward to it’+high-pitched voice waveform,” and so on. The analysis unit outputs emotion labels (e.g., “tense,” “relaxed,” “in a hurry,” etc.) and emotion scores (probability values from 0 to 1) from these inputs. For example, input (1) may output a “tense” label (score 0.78), and input (2) may output a “relaxed” label (score 0.85). Based on the output emotion label and score, the analysis unit applies an analysis method selection algorithm (e.g., threshold judgment+rule-based branching), and selects a fast and simple analysis pipeline (e.g., key keyword extraction+simple intention estimation) when the “tense” score is high, a detailed analysis pipeline (e.g., integration of context and cultural features+multi-stage intention estimation+emotional nuance analysis) when the “relaxed” score is high, and a real-time inference mode (e.g., reduced batch size+accelerated inference) when the “in a hurry” score is high. The AI output is structured data such as (1) analysis method selection label (e.g., “simple,” “detailed,” “fast”), and (2) analysis parameter set (e.g., model ID used, analysis depth, timeout threshold, etc.). For example, in a “tense” state, “simple” label+timeout 2 seconds; in a “relaxed” state, “detailed” label+analysis depth 3 stages; in an “in a hurry” state, “fast” label+batch size 1 are output. In subsequent processing, the analysis unit dynamically switches the utterance analysis pipeline according to the selected analysis method and sends the analysis results to the proposal unit. As a technical effect, the present invention not only automates human emotion observation and selection of analysis methods, but also combines multimodal high-dimensional feature integration analysis and dynamic analysis pipeline control by AI, thereby achieving high-precision and flexible selection of utterance analysis methods tailored to the user's psychological state and situation, which is superior to conventional static rule-based analysis. In terms of causality, the linkage between the output of the emotion estimation AI and the analysis method selection algorithm enables analysis that responds to changes in the user's state, contributing to improved analysis accuracy and user satisfaction. Specific application fields include automatic response for customer support, remote medical interview analysis, educational support chatbots, and stress management support tools. Variations of the embodiment include methods that use biometric sensor data (heart rate, skin potential, etc.) from wearable devices as additional input, real-time video analysis for emotion estimation, large-scale user support via cloud collaboration, and simultaneous optimization of analysis methods for multiple users.

The proposal unit can estimate the emotion of a user and adjust the expression method of the proposal based on the estimated emotion. For example, if the user is tense, a simple and easy-to-understand expression method is proposed. If the user is relaxed, an expression method including detailed information may be proposed. Furthermore, if the user is in a hurry, an expression method that can be quickly understood may be proposed. Thus, appropriate proposals tailored to the user's emotion can be realized. Specifically, the proposal unit simultaneously acquires the user's facial image data (e.g., RGB image, resolution 128×128 pixels), voice waveform data (e.g., 16 kHz sampling, 1-5 seconds audio clip), and utterance text data (e.g., 20-200 tokens of natural language sentences), and preprocesses these using a multimodal feature extractor (e.g., CNN-based facial feature extraction network, acoustic feature extractor, BERT-based text embedding model). The proposal unit integrates the extracted feature quantities (e.g., facial feature vector 256 dimensions, acoustic feature vector 128 dimensions, text embedding vector 768 dimensions) and inputs them to a multimodal emotion estimation model (e.g., Transformer type, with self-attention mechanism, 6 layers, hidden layer size 512). Examples of AI input include (1) “facial image of user frowning+utterance text ‘I'm busy today’+low-pitched voice waveform,” (2) “facial image of user smiling+utterance text ‘I'm looking forward to it’+high-pitched voice waveform,” and so on. The AI outputs emotion labels (e.g., “tense,” “relaxed,” “in a hurry,” etc.) and emotion scores (probability values from 0 to 1). For example, input (1) may output a “tense” label (score 0.78), and input (2) may output a “relaxed” label (score 0.85). Based on the output emotion label and score, the proposal unit applies an expression method selection algorithm (e.g., threshold judgment+rule-based branching), and automatically selects a simple expression using short sentences, bullet points, and plain vocabulary when the “tense” score is high, a rich expression including detailed explanations, supplementary information, and examples when the “relaxed” score is high, and a concise expression extracting only key points when the “in a hurry” score is high. The AI output is structured data such as (1) expression method label (e.g., “simple,” “detailed,” “concise”), and (2) expression parameter set (e.g., sentence length constraint, vocabulary level, number of explanation stages, etc.). For example, in a “tense” state, “simple” label+sentence length 30 tokens; in a “relaxed” state, “detailed” label+sentence length 100 tokens; in an “in a hurry” state, “concise” label+only 3 key points are output. In subsequent processing, the proposal unit dynamically switches the proposal generation pipeline according to the selected expression method, presents the generated proposal to the user, and sequentially accumulates the user's reaction history as learning data. As a technical effect, the present invention not only automates human emotion observation and selection of expression methods, but also combines multimodal high-dimensional feature integration analysis and dynamic expression control by AI, thereby achieving high-precision and flexible selection of proposal expression methods tailored to the user's psychological state and situation, which is superior to conventional static rule-based proposals. In terms of causality, the linkage between the output of the emotion estimation AI and the expression method selection algorithm enables optimal proposal presentation that responds to changes in the user's state, contributing to improved proposal comprehension and user satisfaction. Specific application fields include automatic response for customer support, educational support chatbots, stress management support tools, and medical interview support. Variations of the embodiment include methods that use biometric sensor data (heart rate, skin potential, etc.) from wearable devices as additional input, real-time video analysis for emotion estimation, large-scale user support via cloud collaboration, and simultaneous optimization of expression methods for multiple users.

The receiving unit can adjust the utterance receiving method based on the user's current geographic location information. For example, if the user is in a specific region, utterances related to that region are preferentially received. If the user is traveling, utterances related to the travel destination can be preferentially received. Furthermore, if the user is at home, utterances related to the household can be preferentially received. Thus, appropriate utterance reception based on the user's geographic location information can be realized. Specifically, the receiving unit receives, as input data, GPS location information obtained from the user's device (e.g., latitude/longitude pair, accuracy within 5 meters), Wi-Fi/Bluetooth beacon information, and device location history data (e.g., movement trajectory vector for the past 24 hours). The receiving unit preprocesses this location information using a feature extractor (e.g., one-hot vectorization of location information, time-series vectorization of movement patterns) and generates a current location feature vector (e.g., 128 dimensions). The receiving unit integrates the current location feature vector and region tag/category information of utterance candidates (e.g., region relevance score for each utterance) and inputs them to a filtering AI model (e.g., MLP-type 3-layer network, hidden layer 256, ReLU activation). Examples of AI input include (1) “current location: Chiyoda-ku, Tokyo+utterance candidate: Tokyo event information,” (2) “current location: Kyoto City+utterance candidate: sightseeing guide,” (3) “current location: home (latitude/longitude)+utterance candidate: household communication,” and so on. The AI outputs reception priority score (0 to 1) and reception decision label (e.g., “priority reception,” “normal reception,” “reception pending”). For example, (1) outputs “Tokyo event information: priority reception,” (2) outputs “sightseeing guide: priority reception,” and (3) outputs “household communication: priority reception” as filtering results. In subsequent processing, the receiving unit dynamically controls the display order and reception decision of the utterance reception UI based on the AI output, and sequentially accumulates the user's selection history and location change history as learning data. As a technical effect, the present invention not only automates human location judgment and utterance selection, but also combines high-dimensional feature integration analysis of location information and utterance content and dynamic filtering control by AI, thereby achieving high-precision and flexible utterance reception filtering tailored to the user's current location and movement status, which is superior to conventional static rule-based reception. In terms of causality, the linkage between AI analysis of location features and the receiving unit enables reception that responds to the user's current location and movement patterns, contributing to improved communication efficiency and user satisfaction. Specific application fields include sightseeing guide chatbots, region-limited service reception terminals, support for business communication during travel, and household IoT collaboration reception. Variations of the embodiment include reception control by real-time movement recognition, group reception optimization considering the location information of multiple users, and large-scale location information analysis via cloud collaboration.

The analysis unit can extract keywords contained in the user's utterance and adjust the utterance analysis method based on those keywords. For example, if specific keywords are included, information related to those keywords is preferentially analyzed. The level of detail of analysis can also be adjusted based on the importance of the keywords. Furthermore, the priority of analysis can be set based on the frequency of keyword occurrence. Thus, appropriate utterance analysis utilizing keywords contained in the utterance can be realized. Specifically, the analysis unit receives utterance data (e.g., Japanese text sequence, natural language sentences of length 20-200 tokens, character strings from speech recognition results, etc.), and calculates main keywords and their occurrence frequency and importance score (0 to 1) from the utterance content using a keyword extractor (e.g., TF-IDF-based keyword extraction, BERT-based important word extraction model). The analysis unit applies a keyword weighting AI model (e.g., MLP-type 3-layer network, hidden layer 256, ReLU activation) using the extracted keyword feature quantities (e.g., keyword distribution vector, importance score vector, occurrence frequency histogram, etc.) as input, and outputs (1) analysis method selection label (e.g., “detailed,” “simple,” “fast”), (2) analysis priority score (0 to 1), and (3) analysis parameter set (e.g., model ID used, analysis depth, etc.). Examples of AI input include (1) “keyword: delivery date change+importance 0.9+occurrence frequency 5 times,” (2) “keyword: weekend+importance 0.2+occurrence frequency 1 time,” (3) “keyword: incident report+importance 0.95+occurrence frequency 3 times,” and so on. The AI outputs “detailed” analysis+analysis depth 3 stages for utterances containing high-importance keywords, “simple” analysis+analysis depth 1 stage for low-importance keywords, and “fast” analysis+timeout 1 second for urgent keywords. In subsequent processing, the analysis unit dynamically switches the utterance analysis pipeline according to the selected analysis method and priority, and sends the analysis results to the proposal unit. As a technical effect, the present invention not only automates human keyword extraction and selection of analysis methods, but also combines high-dimensional keyword feature integration analysis and dynamic analysis pipeline control by AI, thereby achieving high-precision and flexible selection of utterance analysis methods tailored to utterance content, keyword importance, and occurrence frequency, which is superior to conventional static rule-based analysis. In terms of causality, the linkage between AI analysis of keyword features and the analysis unit enables analysis that responds to important topics and urgent utterances, contributing to improved analysis accuracy and faster response. Specific application fields include automatic analysis of business communication, emergency notification systems, educational support chatbots, and automatic response for customer support. Variations of the embodiment include personalized keyword criteria for each user, real-time keyword re-evaluation, and large-scale utterance analysis via cloud distributed processing.

The proposal unit can analyze the user's social media activity and make relevant proposals. For example, proposals related to topics frequently mentioned by the user on social media are prioritized. The proposal content can also be adjusted by referring to the user's recent posts on social media. Furthermore, proposals can be made by considering the user's social media friendships. Thus, appropriate proposals utilizing the user's social media activity can be realized. Specifically, the proposal unit receives, as input data, post data obtained from the user's social media account (e.g., the most recent 100 post texts, post times, post category tags), follower/friend lists, and reaction data to posts (e.g., number of likes, comment content, number of shares). The proposal unit extracts features such as topic distribution vector from post content (e.g., topic estimation by LDA or BERT, 128 dimensions), post frequency histogram, and friend relationship graph features (e.g., centrality score, cluster ID). The proposal unit integrates these features and topic tags/relevance scores of proposal candidates, and inputs them to a filtering AI model (e.g., MLP-type 3-layer network, hidden layer 256, ReLU activation). Examples of AI input include (1) “recent post topic: sports+proposal candidate: sports viewing topic,” (2) “friend relationship: technology cluster+proposal candidate: new technology introduction,” (3) “post frequency: many travel category+proposal candidate: travel planning,” and so on. The AI outputs proposal priority score (0 to 1) and proposal decision label (e.g., “priority proposal,” “normal proposal,” “proposal pending”). For example, (1) outputs “sports viewing topic: priority proposal,” (2) outputs “new technology introduction: priority proposal,” and (3) outputs “travel planning: priority proposal” as filtering results. In subsequent processing, the proposal unit dynamically controls the display order and proposal decision of the proposal UI based on the AI output, and sequentially accumulates the user's selection history and social media activity history as learning data. As a technical effect, the present invention not only automates human analysis of post content and selection of proposals, but also combines high-dimensional feature integration analysis of social media activity and proposal content and dynamic filtering control by AI, thereby achieving high-precision and flexible proposal filtering tailored to the user's interests and friendships, which is superior to conventional static rule-based proposals. In terms of causality, the linkage between AI analysis of social media features and the proposal unit enables proposals that respond to the user's latest interests and friendships, contributing to improved communication efficiency and user satisfaction. Specific application fields include personal assistants, automatic response for customer support, SNS-linked chatbots, and information distribution for hobby/interest groups. Variations of the embodiment include integrated analysis of multiple SNS accounts, proposal control by real-time post monitoring, and large-scale social data analysis via cloud collaboration.

Below, the processing flow of Example of the Embodiment is briefly described. Specifically, the system is configured such that the receiving unit, analysis unit, and proposal unit operate in cooperation. The receiving unit receives utterance input from the user (voice, text, image, sensor data, etc.), performs voice recognition, image recognition, and sensor data preprocessing as necessary, and sends the utterance data as structured data to the analysis unit. The analysis unit applies multiple AI models (e.g., Transformer type, LSTM type, MLP type, etc.) stepwise to the received utterance data for multimodal feature extraction, emotion estimation, keyword extraction, category classification, importance estimation, relevance evaluation, and the like, and generates analysis results (e.g., emotion label, intention label, importance score, category label, analysis priority, etc.) for each utterance. The analysis unit dynamically performs branching, detail control, and prioritization of the analysis pipeline based on the analysis results, and sends the optimal analysis results to the proposal unit. The proposal unit comprehensively considers the user's state, utterance content, past history, current activity status, geographic location information, social media activity, etc., based on the analysis results received from the analysis unit, and uses AI models (e.g., generative large language models, MLP-type filtering models, etc.) to determine the optimal proposal content, expression method, level of detail, order, priority, etc., and presents them to the user. The proposal unit sequentially accumulates the user's reaction history and selection results as learning data and reflects them in proposal generation for subsequent sessions. As a technical effect, the present invention not only automates human tasks, but also achieves high-precision, high-efficiency, and highly flexible utterance reception, analysis, and proposal by integrating multimodal high-dimensional feature analysis, cooperation of multiple AI models, dynamic pipeline control, and comprehensive utilization of history, status, emotion, location, and social data, which is superior to conventional static rule-based systems. In terms of causality, the linkage between the output of each AI model and the dynamic control of each unit enables optimal communication support that responds to changes in the user's state and diverse usage scenes, contributing to improved user satisfaction and operational efficiency. Specific application fields include automatic response for customer support, educational support chatbots, medical interview support, business communication support, stress management support, personal assistants, and IoT collaboration services. Variations of the embodiment include large-scale operation on a cloud distributed processing platform, low-latency response via edge device collaboration, secure data management and access control, external service expansion via API collaboration, and addition of anomaly detection and automatic fault recovery functions.

Step 1: The receiving unit receives an utterance input by the user. The utterance may include, for example, voice utterances or text utterances. The receiving unit receives voice input via a microphone and converts it to text data using voice recognition technology. It can also directly receive text input. Step 2: The analysis unit analyzes the utterance received by the receiving unit using generative AI. The analysis is performed using natural language processing technology and emotion analysis technology. The generative AI understands the context and cultural background of the utterance and reads the intention of the counterpart. Step 3: The proposal unit makes an appropriate response proposal to the user based on the result analyzed by the analysis unit. The proposal is made in the form of an action plan or feedback. The proposal unit correctly reads the intention of the counterpart and makes a proposal to the user such as “The counterpart seems to have a different intention.” Specifically, the system receives multimodal input such as voice, text, image, and sensor data via the receiving unit, performs voice recognition (e.g., RNN-based acoustic model+CTC decoder), image recognition (e.g., CNN-based facial expression recognition), and sensor data preprocessing (e.g., time-series normalization), and sends the structured utterance data to the analysis unit. The analysis unit applies multiple AI models stepwise to the received utterance data for multimodal feature extraction (e.g., BERT-based text embedding, CNN-based image feature extraction, LSTM-based time-series feature extraction), emotion estimation (e.g., Transformer-type emotion classification model), keyword extraction (e.g., TF-IDF+BERT), category classification (e.g., BERT-based text classification), importance estimation (e.g., MLP-type importance estimation model), relevance evaluation (e.g., cosine similarity calculation), and generates analysis results (e.g., emotion label, intention label, importance score, category label, analysis priority, etc.) for each utterance. The analysis unit dynamically performs branching, detail control, and prioritization of the analysis pipeline based on the analysis results, and sends the optimal analysis results to the proposal unit. The proposal unit comprehensively considers the user's state, utterance content, past history, current activity status, geographic location information, social media activity, etc., based on the analysis results received from the analysis unit, and uses AI models (e.g., generative large language models, MLP-type filtering models, etc.) to determine the optimal proposal content, expression method, level of detail, order, priority, etc., and presents them to the user. The proposal unit sequentially accumulates the user's reaction history and selection results as learning data and reflects them in proposal generation for subsequent sessions. As a technical effect, the present invention not only automates human tasks, but also achieves high-precision, high-efficiency, and highly flexible utterance reception, analysis, and proposal by integrating multimodal high-dimensional feature analysis, cooperation of multiple AI models, dynamic pipeline control, and comprehensive utilization of history, status, emotion, location, and social data, which is superior to conventional static rule-based systems. In terms of causality, the linkage between the output of each AI model and the dynamic control of each unit enables optimal communication support that responds to changes in the user's state and diverse usage scenes, contributing to improved user satisfaction and operational efficiency. Specific application fields include automatic response for customer support, educational support chatbots, medical interview support, business communication support, stress management support, personal assistants, and IoT collaboration services. Variations of the embodiment include large-scale operation on a cloud distributed processing platform, low-latency response via edge device collaboration, secure data management and access control, external service expansion via API collaboration, and addition of anomaly detection and automatic fault recovery functions.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned receiving unit, analysis unit, and proposal unit is implemented by at least one of, for example, the smart device 14 and the data processing apparatus 12. For example, the receiving unit receives a user's utterance using a microphone 38B or a touch panel 38A of the smart device 14. The analysis unit is implemented by a specific processing unit 290 of the data processing apparatus 12 and analyzes the context and cultural background of the utterance using generative AI. The proposal unit is implemented by the specific processing unit 290 of the data processing apparatus 12 and proposes an appropriate response to the user based on the analysis result. The correspondence between each unit and the apparatus or control unit is not limited to the examples described above and various modifications are possible.

### [Second Embodiment]

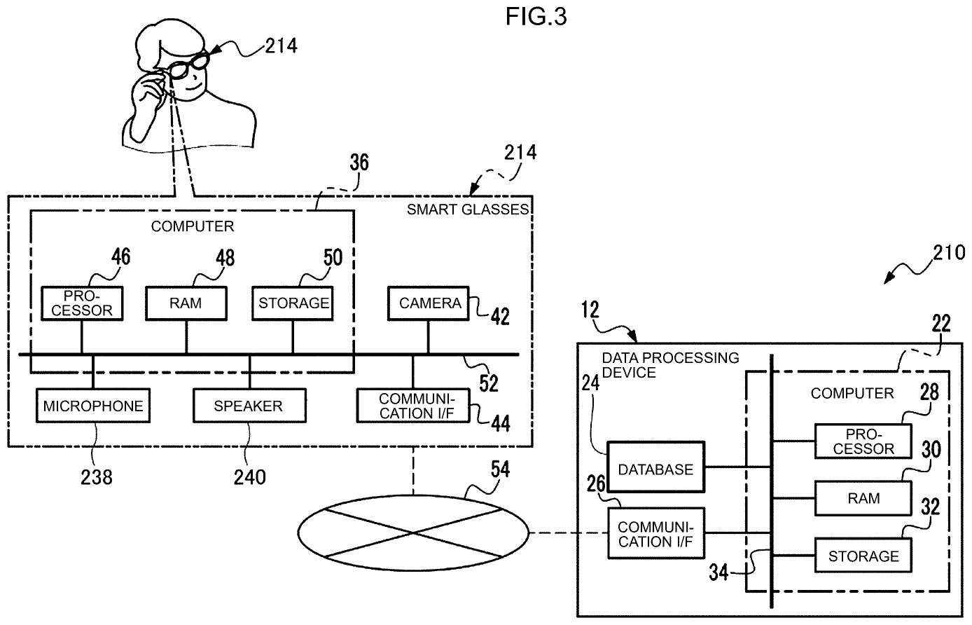

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

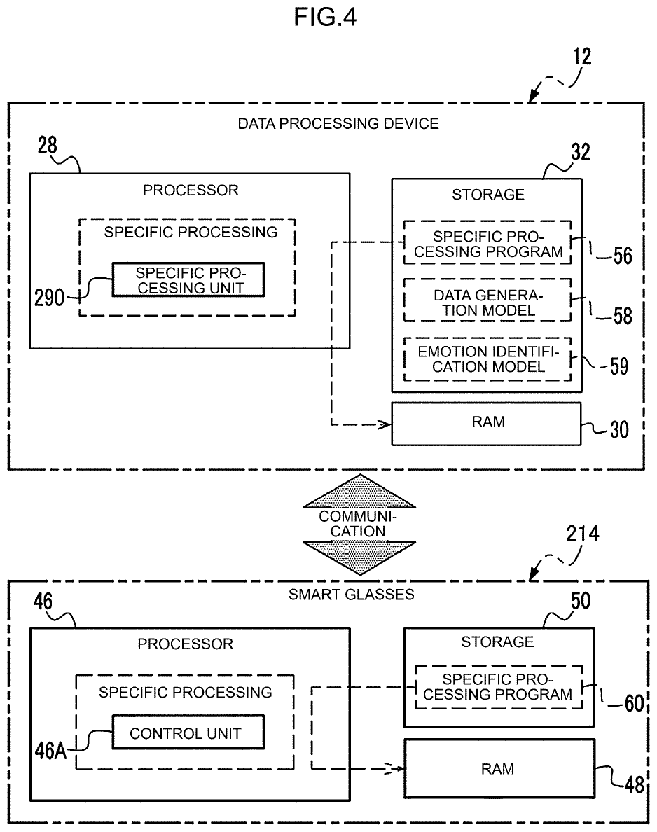

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned receiving unit, analysis unit, and proposal unit is implemented by at least one of, for example, the smart glasses 214 and the data processing apparatus 12. For example, the receiving unit receives a user's utterance using a microphone 238 of the smart glasses 214. The analysis unit is implemented by a specific processing unit 290 of the data processing apparatus 12 and analyzes the context and cultural background of the utterance using generative AI. The proposal unit is implemented by the specific processing unit 290 of the data processing apparatus 12 and proposes an appropriate response to the user based on the analysis result. The correspondence between each unit and the apparatus or control unit is not limited to the examples described above and various modifications are possible.

### [Third Embodiment]

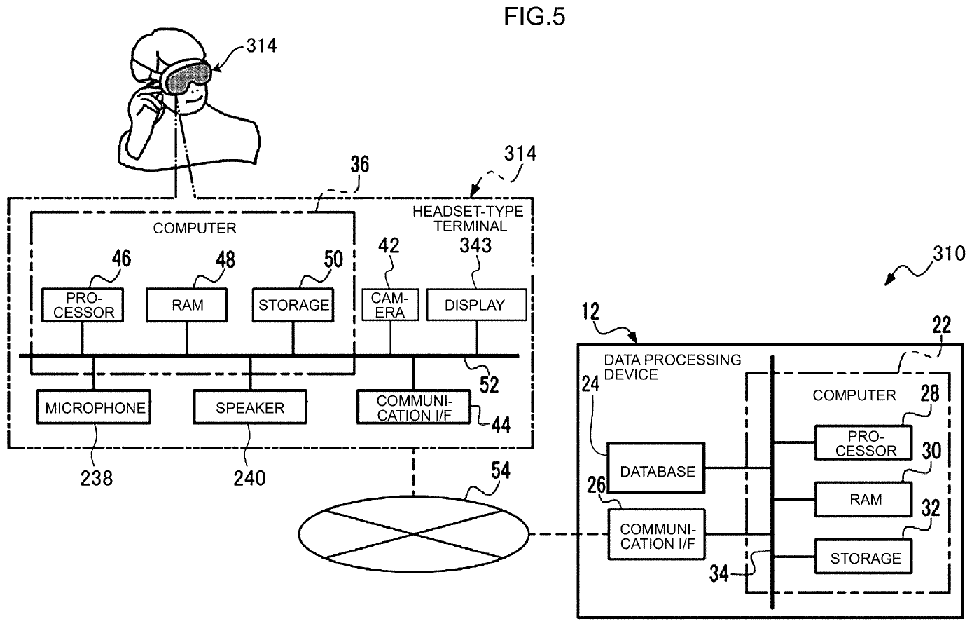

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

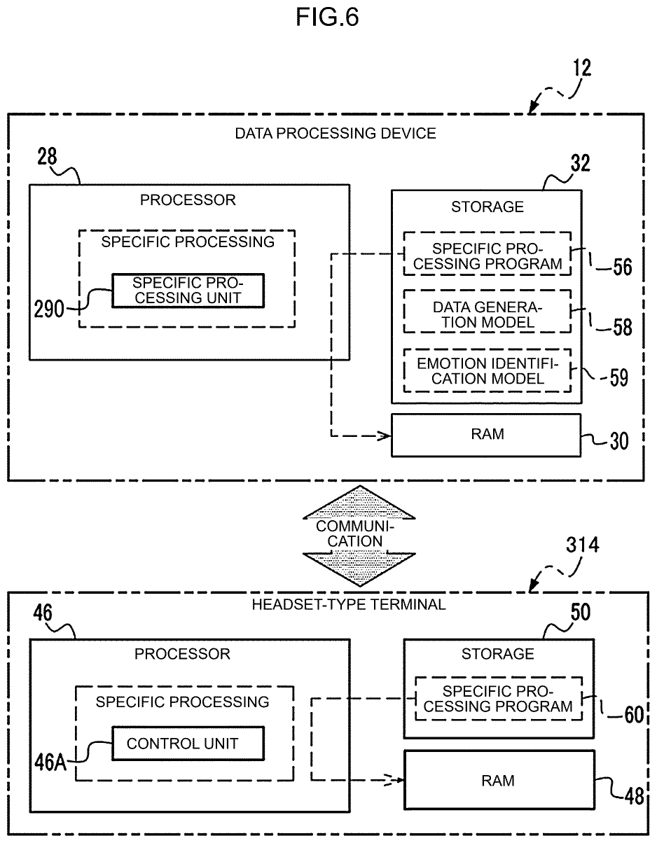

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned receiving unit, analysis unit, and proposal unit is implemented by at least one of, for example, the headset-type terminal 314 and the data processing apparatus 12. For example, the receiving unit receives a user's utterance using a microphone 238 of the headset-type terminal 314. The analysis unit is implemented by a specific processing unit 290 of the data processing apparatus 12 and analyzes the context and cultural background of the utterance using generative AI. The proposal unit is implemented by the specific processing unit 290 of the data processing apparatus 12 and proposes an appropriate response to the user based on the analysis result. The correspondence between each unit and the apparatus or control unit is not limited to the examples described above and various modifications are possible.

### [Fourth Embodiment]

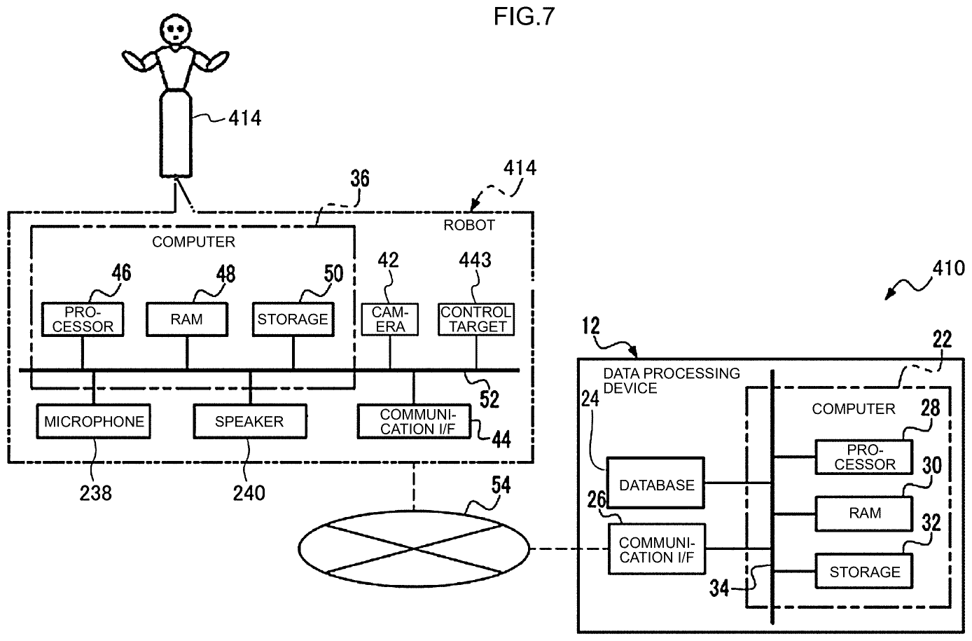

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

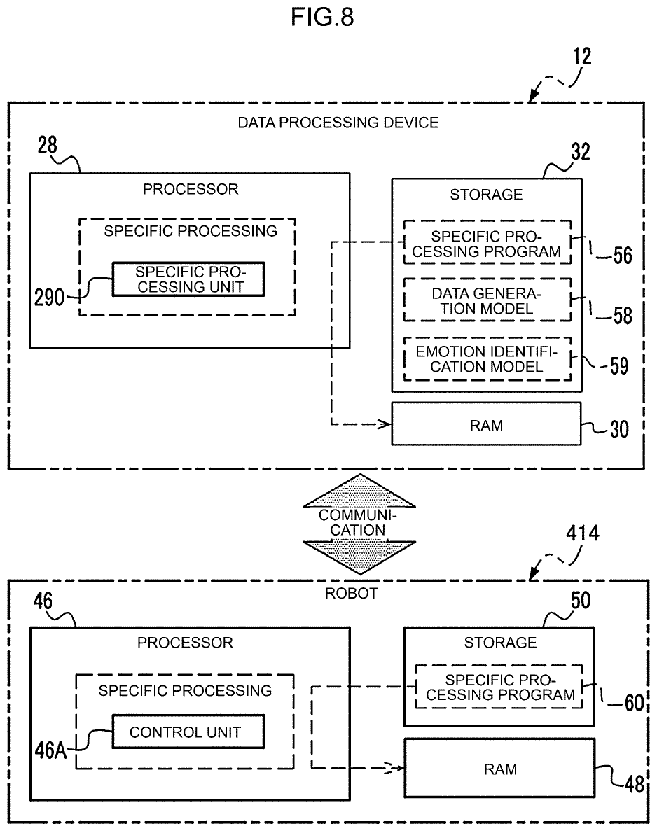

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned receiving unit, analysis unit, and proposal unit is implemented by at least one of, for example, the robot 414 and the data processing apparatus 12. For example, the receiving unit receives a user's utterance using a microphone 238 of the robot 414. The analysis unit is implemented by a specific processing unit 290 of the data processing apparatus 12 and analyzes the context and cultural background of the utterance using generative AI. The proposal unit is implemented by the specific processing unit 290 of the data processing apparatus 12 and proposes an appropriate response to the user based on the analysis result. The correspondence between each unit and the apparatus or control unit is not limited to the examples described above and various modifications are possible.

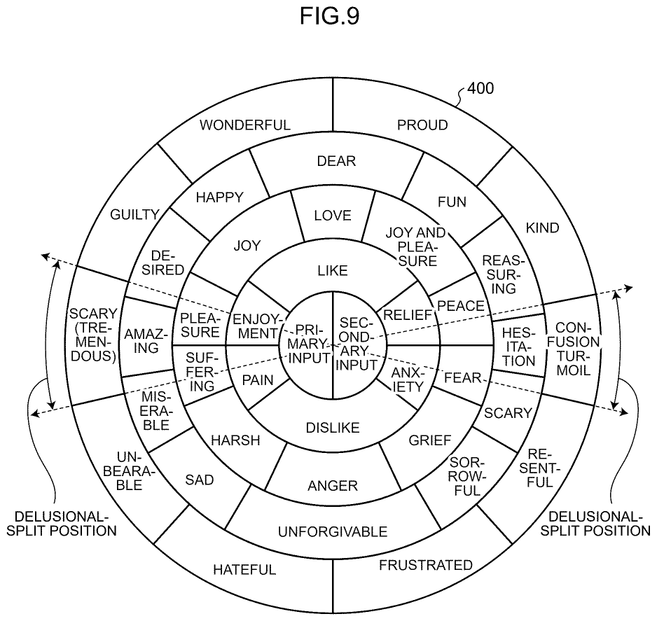

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

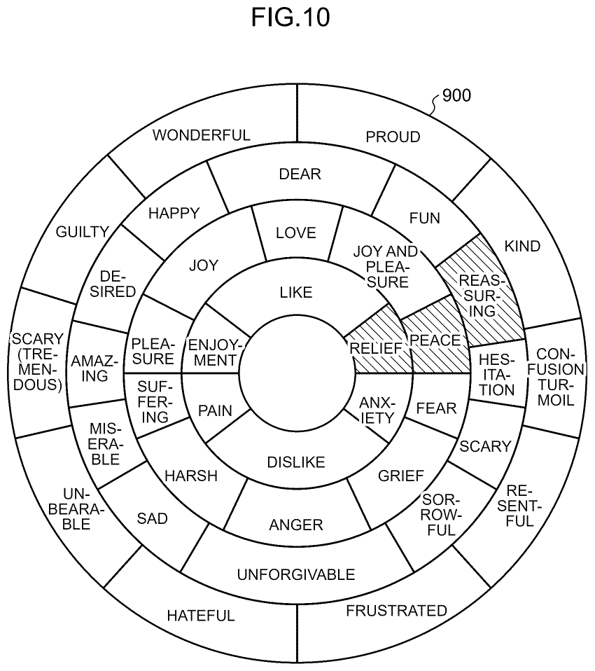

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a receiving unit configured to receive an utterance input; an analysis unit configured to analyze the utterance input received by the receiving unit; and a proposal unit configured to make a proposal based on a result analyzed by the analysis unit.
(Supplementary Note 2) The system according to Supplementary Note 1, wherein the analysis unit is configured to analyze a context and cultural background of the utterance.
(Supplementary Note 3) The system according to Supplementary Note 1, wherein the proposal unit is configured to analyze an intention of the counterpart.
(Supplementary Note 4) The system according to Supplementary Note 1, wherein the proposal unit is configured to propose a response to a user.
(Supplementary Note 5) The system according to Supplementary Note 1, wherein the receiving unit is configured to estimate an emotion of a user and adjust a timing for receiving the utterance based on the estimated emotion of the user.
(Supplementary Note 6) The system according to Supplementary Note 1, wherein the receiving unit is configured to analyze a user's past utterance history and select a receiving method.
(Supplementary Note 7) The system according to Supplementary Note 1, wherein the receiving unit is configured to perform filtering at the time of receiving the utterance based on a current situation and field of interest of the user.
(Supplementary Note 8) The system according to Supplementary Note 1, wherein the receiving unit is configured to estimate an emotion of a user and determine a priority of the utterance to be received based on the estimated emotion of the user.
(Supplementary Note 9) The system according to Supplementary Note 1, wherein the receiving unit is configured to preferentially receive utterances with high relevance based on geographic location information of the user at the time of receiving the utterance.
(Supplementary Note 10) The system according to Supplementary Note 1, wherein the receiving unit is configured to analyze social media activity of the user at the time of receiving the utterance and receive relevant utterances.
(Supplementary Note 11) The system according to Supplementary Note 1, wherein the analysis unit is configured to estimate an emotion of a user and adjust an analysis method for the utterance based on the estimated emotion of the user.
(Supplementary Note 12) The system according to Supplementary Note 1, wherein the analysis unit is configured to set a level of detail of analysis based on an importance of the utterance at the time of analyzing the utterance.
(Supplementary Note 13) The system according to Supplementary Note 1, wherein the analysis unit is configured to use different analysis algorithms according to a category of the utterance at the time of analyzing the utterance.
(Supplementary Note 14) The system according to Supplementary Note 1, wherein the analysis unit is configured to estimate an emotion of a user and determine a priority of analysis based on the estimated emotion of the user.
(Supplementary Note 15) The system according to Supplementary Note 1, wherein the analysis unit is configured to set a priority of analysis based on a submission timing of the utterance at the time of analyzing the utterance.
(Supplementary Note 16) The system according to Supplementary Note 1, wherein the analysis unit is configured to set an order of analysis based on a relevance of the utterance at the time of analyzing the utterance.
(Supplementary Note 17) The system according to Supplementary Note 1, wherein the proposal unit is configured to estimate an emotion of a user and adjust an expression method of the proposal based on the estimated emotion of the user.
(Supplementary Note 18) The system according to Supplementary Note 1, wherein the proposal unit is configured to set a level of detail of the proposal based on an importance of the utterance at the time of making the proposal.
(Supplementary Note 19) The system according to Supplementary Note 1, wherein the proposal unit is configured to use different proposal algorithms according to a category of the utterance at the time of making the proposal.
(Supplementary Note 20) The system according to Supplementary Note 1, wherein the proposal unit is configured to estimate an emotion of a user and adjust a length of the proposal based on the estimated emotion of the user.
(Supplementary Note 21) The system according to Supplementary Note 1, wherein the proposal unit is configured to set a priority of the proposal based on a submission timing of the utterance at the time of making the proposal.
(Supplementary Note 22) The system according to Supplementary Note 1, wherein the proposal unit is configured to set an order of the proposal based on a relevance of the utterance at the time of making the proposal.

What is claimed is:

1. A system comprising:
a communication interface configured to communicate with a client terminal via a packet-switched network;
a memory storing a data generation model comprising a Transformer-based large language model obtained by deep learning on a neural network, and an emotion identification model; and
circuitry configured to:
receive, from the client terminal via the communication interface, utterance data comprising at least one of voice data or text data;
extract feature vectors from the utterance data using a multimodal feature extractor comprising at least one of an acoustic feature extractor or a text embedding model;
analyze the utterance data by inputting the feature vectors into the data generation model to generate analysis data comprising an intention label and an intention score indicating an intention behind the utterance data;
generate, using the data generation model, proposal data comprising a response proposal based on the analysis data; and
transmit the proposal data to the client terminal via the communication interface and the packet-switched network, the proposal data causing the client terminal to output the proposal data to a user.

2. The system according to claim 1, wherein the circuitry is further configured to analyze a context and a cultural background of the utterance data by extracting place names, idioms, and cultural reference terms from the utterance data and matching the extracted terms with an external knowledge base stored in a database.

3. The system according to claim 1, wherein the analysis data further comprises an estimated emotion value, and wherein the intention label comprises at least one of a direct proposal label, an evasive refusal label, or a social nicety label.

4. The system according to claim 1, wherein the proposal data comprises at least one of a text message, an action plan, or a cautionary message indicating an appropriate response to the utterance data.

5. The system according to claim 1, wherein the circuitry is further configured to estimate an emotion of the user by applying the emotion identification model to at least one of voice data, a face image, or text input received from the client terminal, and to adjust a timing of receiving the utterance data based on the estimated emotion.

6. The system according to claim 5, wherein the circuitry is configured to delay receiving the utterance data when the estimated emotion indicates tension, and to receive the utterance data after a cool-down period when the estimated emotion indicates excitement.

7. The system according to claim 1, wherein the circuitry is further configured to analyze a past utterance history of the user stored in a database, extract a topic distribution vector from the past utterance history, and select a receiving method for the utterance data based on the topic distribution vector.

8. The system according to claim 1, wherein the circuitry is further configured to receive current situation data of the user from the client terminal, the current situation data comprising at least one of location information or activity status, and to filter the utterance data based on the current situation data and a field of interest of the user.

9. The system according to claim 1, wherein the circuitry is further configured to estimate an emotion of the user by applying the emotion identification model to sensor data received from the client terminal, and to determine a priority of the utterance data to be received based on the estimated emotion, such that when the estimated emotion indicates tension, the circuitry prioritizes important utterance data.

10. The system according to claim 1, wherein the circuitry is further configured to receive geographic location information of the user from the client terminal, and to preferentially receive utterance data having high relevance to a geographic region corresponding to the geographic location information.

11. The system according to claim 1, wherein the circuitry is further configured to receive social media activity data of the user from the client terminal, extract a topic distribution vector from the social media activity data using a natural language processing model, and receive utterance data relevant to the extracted topic distribution vector.

12. The system according to claim 1, wherein the circuitry is further configured to estimate an emotion of the user by applying the emotion identification model to sensor data received from the client terminal, and to adjust an analysis method for the utterance data based on the estimated emotion, such that when the estimated emotion indicates tension, the circuitry applies a simplified analysis pipeline, and when the estimated emotion indicates relaxation, the circuitry applies a detailed analysis pipeline.

13. The system according to claim 1, wherein the circuitry is further configured to calculate an importance score for the utterance data, and to adjust a level of detail of the analysis data based on the importance score, such that detailed analysis is performed for utterance data having a high importance score.

14. The system according to claim 1, wherein the circuitry is further configured to apply different analysis algorithms according to a category of the utterance data, such that for business-related utterance data, the circuitry applies a business analysis algorithm, and for daily conversation utterance data, the circuitry applies a daily conversation analysis algorithm.

15. The system according to claim 1, wherein the circuitry is further configured to estimate an emotion of the user by applying the emotion identification model to sensor data received from the client terminal, and to adjust an expression method of the proposal data based on the estimated emotion, such that when the estimated emotion indicates tension, the proposal data is generated in a simple expression style, and when the estimated emotion indicates relaxation, the proposal data is generated in a detailed expression style.

16. The system according to claim 1, wherein the circuitry is further configured to calculate an importance score for the utterance data, and to adjust a level of detail of the proposal data based on the importance score, such that detailed proposal data is generated for utterance data having a high importance score.

17. The system according to claim 1, wherein the circuitry is further configured to determine a priority of generating the proposal data based on a submission timing associated with the utterance data, such that utterance data having a more recent submission timing is processed with a higher priority.

18. A system comprising:
a communication interface configured to communicate, via a packet-switched network conforming to at least one of a 5G, Wi-Fi, or Bluetooth communication standard, with a client terminal comprising a microphone, a speaker, a camera having a CMOS image sensor, a touch panel, and a display;
a processor;
a random-access memory;
a memory storing a data generation model comprising a Transformer-based large language model with a self-attention mechanism obtained by deep learning on a neural network, and an emotion identification model;
a database; and
circuitry configured to:
receive, from the client terminal via the communication interface, utterance data comprising at least one of voice data captured by the microphone or text data input via the touch panel;
extract feature vectors from the utterance data using a multimodal feature extractor, the feature vectors comprising at least one of an acoustic feature vector or a text embedding vector;
extract context information from an utterance history stored in the database as time-series tensors;
analyze the utterance data by inputting the feature vectors and the context information into the data generation model to generate analysis data comprising an intention label, an intention score, and an estimated emotion value;
estimate an emotion of the user by applying the emotion identification model to at least one of the voice data or a face image captured by the camera;
generate, using the data generation model, proposal data comprising a response proposal based on the analysis data, the proposal data being adapted based on the estimated emotion; and
transmit the proposal data to the client terminal via the communication interface, the proposal data causing the client terminal to output the proposal data to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a data generation model comprising a Transformer-based large language model obtained by deep learning on a neural network and an emotion identification model, the method comprising:
receiving, from a client terminal via the communication interface and a packet-switched network, utterance data comprising at least one of voice data or text data;
extracting feature vectors from the utterance data using a multimodal feature extractor comprising at least one of an acoustic feature extractor or a text embedding model;
analyzing the utterance data by inputting the feature vectors into the data generation model to generate analysis data comprising an intention label and an intention score indicating an intention behind the utterance data;
generating, using the data generation model, proposal data comprising a response proposal based on the analysis data; and
transmitting the proposal data to the client terminal via the communication interface and the packet-switched network, the proposal data causing the client terminal to output the proposal data to a user.
